(19) United States
(12) Patent Application Publication
(10) Pub. No.: US 2019/0029423 A1
(43) Pub. Date: Jan. 31, 2019

(54) ARTICLE EQUIPPED WITH OVERTURN PREVENTING DEVICE

(71) Applicant: KYB CORPORATION, Minato-ku, Tokyo (JP)

(72) Inventors: Shinichi SEKINE, Minato-ku, Tokyo (JP); Akihisa OTA, Minato-ku, Tokyo (JP); Masaya UNE, Minato-ku, Tokyo (JP); Atsushi TOYOUCHI, Minato-ku, Tokyo (JP); Yukiko ISHIHARA, Minato-ku, Tokyo (JP); Chika IIDA, Minato-ku, Tokyo (JP)

(73) Assignee: KYB CORPORATION, Minato-ku, Tokyo (JP)

(21) Appl. No.: 16/069,327

(22) PCT Filed: Jan. 6, 2017
(86) PCT No.: PCT/JP2017/000298

§ 371 Date: Jul. 11, 2018

(30) Foreign Application Priority Data
Jan. 20, 2016 (JP) 2016-008396

(51) Int. Cl. A47B 97/00; F16F 9/06

(52) U.S. Cl. CPC A47B 97/00; A47B 2097/008; F16F 9/061

(57) ABSTRACT

Providing an article equipped with an overturn preventing device, which can add an overturn preventing function to the article itself and can reduce work burdens and management burdens at the time of the mounting. A piece of furniture includes a furniture body to be disposed between an installation surface and a ceiling at a time of installation and an abutting member to be disposed between the ceiling and the furniture body at the time of installation. The furniture further includes an operating part having a damper having two ends one of which is coupled to the furniture body and the other of which is coupled to the abutting member. The operating part is operated such that the damper becomes a contracted state when the abutting member is disposed at an initial position near the article body side and that the abutting member is moved to a developed position upwardly farther away from the furniture body than the initial position according to extension of the damper thereby to be caused to abut against the ceiling.

### TECHNICAL FIELD

The present invention relates to an article equipped with an overturn preventing device.

### BACKGROUND ART

Patent Document 1 discloses a conventional overturn preventing device. This overturn preventing device includes a damper and a pair of bases. The damper is mounted between a top surface of a piece of furniture installed on a floor surface and a ceiling. The bases respectively support two ends of the damper so that the ends of the damper are rotatable about rotation axes. One of the bases abuts against the top surface of the furniture and the other base abuts against the ceiling. Accordingly, when the furniture is tilted by shaking of earthquake or the like in a direction parallel to a rotation direction of the damper, the damper is rotated about the rotation axes relative to the bases with the result that the bases can respectively be maintained in abutment against the top surface of the furniture and the ceiling. Consequently, the overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

However, since the overturn preventing device of Patent Document 1 is configured as a device independent of an article to which the overturn preventing device is to be mounted, carry, installation, parts management etc. of the overturn preventing device need to be executed separately from the article. Furthermore, when the overturn preventing device is to be placed and mounted on the article, a work is required to properly set a placement position on the article. Accordingly, the conventional overturn preventing device results in an increase of burdens in at least these respects.

### Means for Overcoming the Problem

The present invention was made in view of the above-described circumstances in the conventional art and has an object to provide an article equipped with an overturn preventing device, which can add an overturn preventing function to the article itself and can reduce work burdens and management burdens at the time of mounting.

An article equipped with an overturn preventing device, according to the invention includes an article body to be disposed between an installation surface and a ceiling at a time of installation and an abutting member to be disposed between either the installation surface or the ceiling and the article body at the time of installation. The article further includes an operating part having a damper having two ends one of which is coupled to the article body and the other of which is coupled to the abutting member. The operating part moves the abutting member to an initial position near the article body side according to contraction of the damper, and moves the abutting member to a developed position farther away from the article body than the initial position according to extension of the damper.

In the article equipped with the overturn preventing device according to the invention, the abutting member is disposed between either the installation surface or the ceiling and the article body at the time of installation, and the article body and the abutting member are operated so as to move away from each other by the extension of the damper of the operating part. As a result, this article equipped with the overturn preventing device can stably be installed while being placed on the installation surface and pressing the ceiling. Furthermore, since the damper is interposed between the article body and the abutting member while being coupled to the article body and the abutting member, a damping force is generated by the extending/contracting operation in accordance with shaking of the article body or the abutting member at the time of installation. Therefore, the shaking of the article body and the abutting member can be suppressed, with the result that the effect of preventing the article from overturn can be enhanced. Moreover, management burdens can be reduced since the article body, the abutting member, the damper and the like can be managed in an integrated manner. Furthermore, since the damper can be previously coupled to the article body and the abutting member thereby to be positioned, work burdens of mounting, positioning etc. of the damper to the article body can be reduced at the time of installation of the article.

Accordingly, the overturn preventing function can be added to the article itself, and the work burdens and management burdens at the time of mounting can be reduced.

Two damper sets each including a pair of the dampers may respectively be mounted at both sides in a predetermined width direction of the article body. Each damper set may have a distance increasing part in which a front-back distance between one damper and the other damper in a predetermined front-back direction perpendicular to the width direction becomes larger as coming close to the abutting member.

According to this configuration, both widthwise sides of the abutting member can be supported at a plurality of positions when the abutting member is operated to be moved away from the article body. Furthermore, since forces from the dampers act on both the front side and the rear side at both widthwise sides of the abutting member, the forces applied to the abutting member from the dampers can be restrained from being excessively biased to one of the sides in the front-back direction.

When the damper sets of paired dampers are thus respectively to be mounted at both widthwise sides of the article body, each damper set may have a front side damper having a coupling position to the abutting member, which position is located ahead of a coupling position to the article body, and a rear side damper having a coupling position to the abutting member, which position is located in a rear of a coupling position to the article body.

According to this configuration, even when the article body is tilted to the front side or tilted to the rear side, the force tilting the article can effectively be damped with the result that the tilt of the article body can be suppressed. Consequently, stable installation becomes possible even when there is no wall adjacent to the front and the back of the article as well as when there is a wall adjacent to the front or the back of the article body.

In the article equipped with the overturn preventing device according to the invention, the operating part may have a link coupling the abutting member and the article body and configured to be displaced according to extension/contraction of the damper. The link may incline the damper and guide the abutting member to the initial position side when the damper is contracted, and may raise the damper and guide the abutting member to the developed position in conjunction with extension of the damper.

According to this configuration, the damper can be inclined at the time when the damper is contracted, so that the entire article can be rendered compact. At the time of installation, the link can be operated in conjunction with extension of the damper so that the damper can automatically be raised.

The article equipped with the overturn preventing device according to the invention may further include a guide which limits a horizontal movement range of the abutting member when the damper is extended/contracted.

According to this configuration, the abutting member can be disposed without being largely away from the article body horizontally at the time when the damper is contracted, so that the article can be configured more compactly. At the time when the damper is extended, the abutting member can be moved away without being largely away from the article body horizontally.

The article according to the invention may further include a distance limiter which prevents a distance between the abutting member and the article body from being increased over a previously set maximum distance. According to this configuration, the distance between the abutting member and the article body can be kept no more than the maximum distance, with the result that defects due to exceeding the maximum distance can be prevented.

In the article equipped with the overturn preventing device according to the invention, the article body may include a sidewall and an upper wall. The upper wall may be formed with an opening penetrating therethrough. The damper may be coupled to an inner wall side of the sidewall and inserted through the opening of the upper wall.

According to this configuration, an interior of the article body can be used as an arrangement space of the damper. And at the time when the damper is contracted, the abutting member can be caused to come closer to the article body thereby to be disposed more compactly.

In the article equipped with the overturn preventing device according to the invention, the dampers may respectively be coupled to both widthwise ends of the article body. When the dampers are thus mounted so as to be largely separated from each other in the width direction, a wide region between the dampers disposed at both widthwise sides can be ensured in the region between the abutting member and the article body at the time of installation of the article. As a result, the region which is thus widely ensured can effectively be used as a storage space and the like.

In the article equipped with the overturn preventing device according to the invention, a plurality of the dampers may be coupled to the article body at an identical coupling position. The article may further include an article body side adjuster which adjusts the coupling position of the dampers in the article body. According to this configuration, the coupling position of the dampers in the article body can be set at a desirable position according to the surroundings in which the article is installed. Moreover, since a plurality of the dampers is coupled at an identical coupling position in any position adjusted by the adjuster, the number of parts can be reduced and workability can be improved as compared with the configuration in which the dampers are adjusted to be positioned individually.

The article includes furniture, a bed having a plurality of beds connected to each other in the up-down direction, large sized televisions, refrigerators, book shelves, showcases, server racks, and the like all of which have a possibility of being overturned by shaking of earthquake or the like.

### BRIEF DESCRIPTION OF THE DRAWINGS

FIG. 1 is a schematic partially sectional view of the article equipped with an overturn preventing device, in accordance with a first embodiment;

FIG. 2 is a perspective view of a part of the article of the first embodiment;

FIG. 3 is a schematic partially sectional view of the article equipped with the overturn preventing device, in accordance with a second embodiment;

FIG. 4 is a perspective view of a part of the article of the second embodiment;

FIG. 5 is a schematic partially sectional view of the article equipped with the overturn preventing device, in accordance with a third embodiment;

FIG. 6 is a perspective view of a part of the article of the third embodiment;

FIG. 7 is a schematic partially sectional view of the article of the third embodiment;

FIG. 8 is an illustration of the article of the third embodiment, with a changed level;

FIG. 9 is a schematic partially sectional view of the article equipped with the overturn preventing device, in accordance with a fourth embodiment;

FIG. 10 is a schematic sectional view of the article of the fourth embodiment, located at a developed position;

FIG. 11 is a schematic partially sectional view of the article equipped with the overturn preventing device, in accordance with a fifth embodiment;

FIG. 12 is a schematic partially sectional view of the article equipped with the overturn preventing device, in accordance with a sixth embodiment;

FIG. 13 is an illustration of the article of the sixth embodiment, located at an initial position;

FIG. 14 is an illustration of the article of the sixth embodiment, located at the developed position;

FIG. 15 is a schematic partially sectional view of the article equipped with the overturn preventing device, in accordance with a seventh embodiment;

FIG. 16 is an illustration of the article of the seventh embodiment, located at the initial position;

FIG. 17 is an illustration of the article of the seventh embodiment, located at the developed position; and

FIG. 18 is a schematic partially sectional view of the article equipped with the overturn preventing device, in accordance with an eighth embodiment.

### BEST MODE FOR CARRYING OUT THE INVENTION

A first embodiment of the article equipped with overturn preventing device, in accordance with the present invention will be described with reference to the drawings.

### First Embodiment

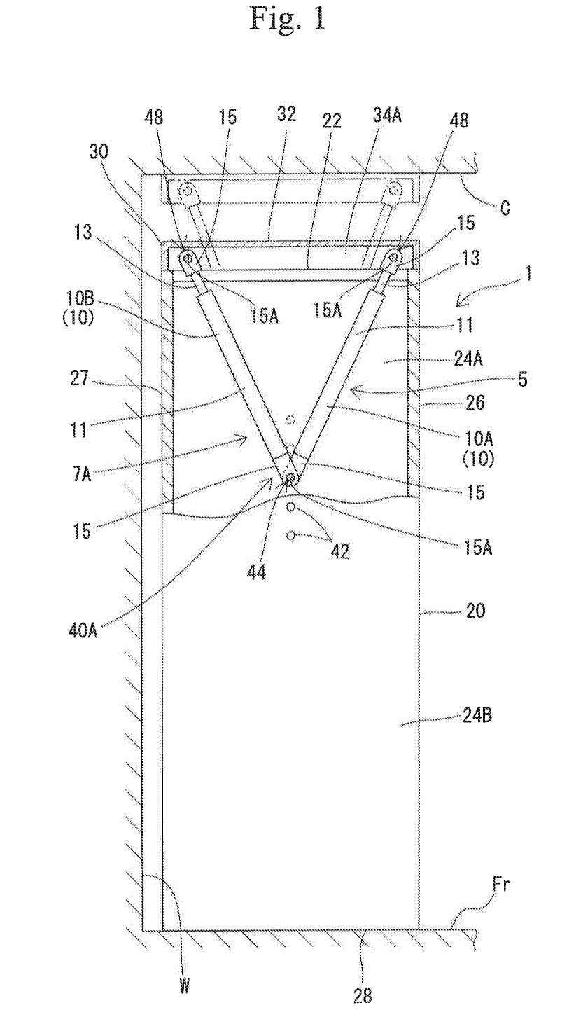

A piece of furniture 1 illustrated in FIG. 1 includes a furniture body 20 disposed between an installation surface Fr and a ceiling C at a time of installation of the furniture 1, and a plate-shaped abutting member 30 disposed between the ceiling C and the furniture body 20 at the time of installation of the furniture 1, and an operating part 5. The furniture 1 serves as an example of an article equipped with an overturn preventing device in accordance with the invention. The operating part 5 has a plurality of dampers 10. Each damper 10 has two ends one of which is coupled to the furniture body 20 and the other of which is coupled to the abutting member 30. The operating part 5 is configured such that each damper 10 becomes a contracted state when the abutting member 30 is disposed at an initial position near the furniture body 20 side, as illustrated by solid line in FIG. 1. The operating part 5 is operated such that the abutting member 30 is moved to a developed position upwardly farther away from the furniture body 20 than the initial position according to extension of the dampers 10 thereby to be caused to abut against the ceiling C, as illustrated by two-dot chain line in FIG. 1.

In the present configuration, when the furniture 1 is placed on a flat installation surface Fr, a direction perpendicular to the installation surface Fr is an up-down direction of the furniture 1. If the installation surface Fr is a horizontal surface perpendicular to the vertical direction, the vertical direction is the up-down direction. A predetermined direction perpendicular to the up-down direction is a width direction, and a direction perpendicular to the up-down direction and the width direction is a front-back direction.

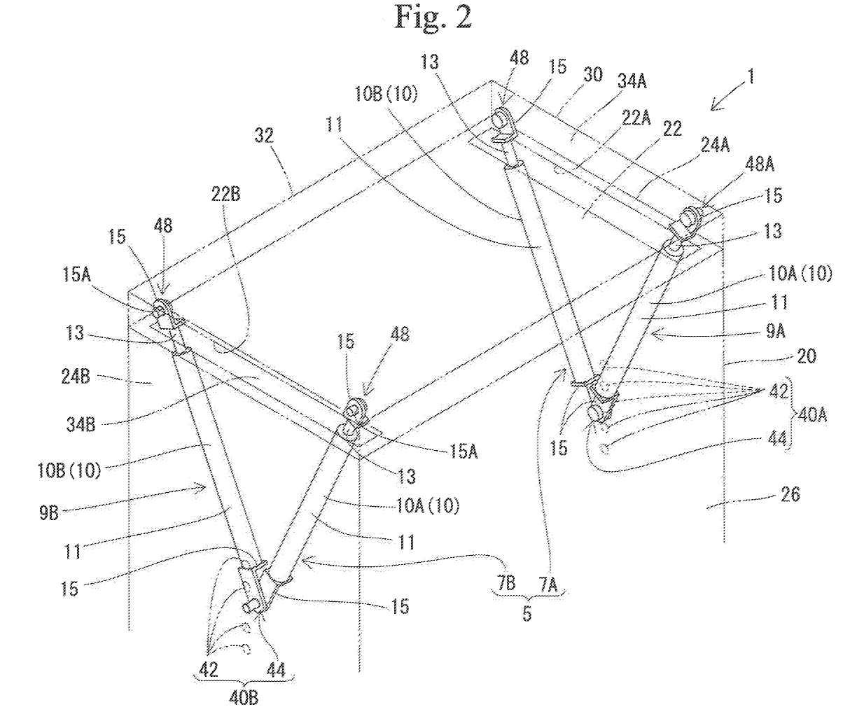

A longitudinal direction of sidewalls 24A and 24B is the up-down direction in the example illustrated in FIGS. 1 and 2. Furthermore, in the example illustrated in FIGS. 1 and 2, the paired sidewalls 24A and 24B constructing the furniture body 20 are disposed to be opposed to each other while inner wall surfaces of the sidewalls 24A and 24B are kept parallel to each other. A direction in which the paired sidewalls 24A and 24B are opposed to each other is the width direction. More specifically, the furniture body 20 has a profile that is rectangular in a planar view. A longer side direction in the planar view of the furniture body 20 (the direction of a longer side of the rectangular profile in the planar view) can be set as the width direction. A shorter side direction in the planar view of the furniture body 20 (the direction of a shorter side of the rectangular profile in the planar view) can be set as the front-back direction. In FIG. 2, the furniture body 20 and outer walls (a frame) of the abutting member 30 are illustrated by two-dot chain lines in FIG. 2.

FIG. 1 illustrates an example of installed condition of the furniture 1. The furniture body 20 is placed on the installation surface Fr (a floor surface in a room, for example) with a back surface 27 being opposed to a wall W in the example of FIG. 1. When the overturn preventing device is not mounted on the furniture 1, the furniture body 20 would possibly be tilted particularly in a front-back direction (a right-left direction in FIG. 1) by shaking of earthquake or the like thereby to be overturned. In view of this, the operating part 5 and the abutting member 30 are functioned as an overturn preventing device in the furniture 1.

The furniture body 20 is formed into a rectangular parallelepiped shape and surrounded by a front surface 26 and the back surface 27 opposed to each other in the front-back direction and the sidewalls 24A and 24B opposed to each other in the width direction, with the result that a housing space is defined therein. The furniture body 20 has an upper end provided with an upper wall 22 and a lower end provided with a lower wall 28 (a bottom wall), so that the furniture body 20 has a box-like shape as a whole. For example, the furniture body 20 is structured such that a part of or entire front surface 26 is openable/closable or is normally open, whereby the furniture body 20 is structured to be capable of housing clothes, accessories and the like. Here, the furniture body 20 is a mere example, and various known structures of pieces of furniture can be employed.

As illustrated in FIG. 2, the operating part 5 includes two damper sets 7A and 7B each of which is composed of two dampers 10. All the dampers 10 composing the damper sets 7A and 7B have the same structure.

Each damper 10 includes a cylinder 11, a rod guide (not illustrated), a piston (not illustrated), a rod 13, and two joints 15 respectively provided on two ends of the damper 10, as illustrated in FIG. 2. The cylinder 11 is formed into a bottomed cylindrical shape. The cylinder 11 has an opening closed by the rod guide. The piston is slidably inserted into the cylinder 11. The rod 13 has a proximal end connected to the piston. Furthermore, the rod 13 has a distal end which is inserted through the rod guide to protrude out of the cylinder 11. A hydraulic fluid and a compressed gas are enclosed in the cylinder 11. The joints 15 are each formed by bending a flat plate-shaped metal fitting. The joints 15 are respectively connected to the bottom of the cylinder 11 and a distal end of the rod 13. Each joint 15 has a through hole 15A extending therethrough in a direction perpendicular to axis lines of the damper 10. Coupling members 44 or 48 which will be described later are respectively inserted through the through holes 15A.

Each one of the dampers 10 composing the damper sets 7A and 7B is a compression damper in which a damping force generated during an extending operation is smaller than a damping force generated during a contracting operation. The extending operation of the damper 10 refers to an operation which increases an amount of protrusion of the rod 13 out of the cylinder 11 and a length of the damper 10. The contracting operation of the damper 10 refers to an operation which reduces an amount of protrusion of the rod 13 out of the cylinder 11 and the length of the damper 10. An expansion force of the compressed gas enclosed in the cylinder 11 works in an extension direction of the damper 10.

The following will describe a mechanism of generating a damping force by each damper 10. Since the mechanism has a known structure, diagrammatic representation is eliminated. The cylinder 11 has an interior divided by the piston into a rod-side pressure chamber in which the proximal end of the rod 13 is housed and a counter-rod-side pressure chamber. The piston is formed with an orifice which is a throttle valve communicating between both pressure chambers. The orifice functions as a damping force generator which applies resistance to a flow of the hydraulic fluid between the rod-side pressure chamber and the counter-rod-side pressure chamber with the extending/contracting operation of the damper 10. Furthermore, the piston is formed with a communication path communicating via a check valve with both pressure chambers. The check valve allows the hydraulic fluid to flow from the rod-side pressure chamber to the counter-rod-side pressure chamber and blocks reverse flow of the hydraulic fluid. Accordingly, the damper 10 has two flow paths of the hydraulic fluid from the rod-side pressure chamber to the counter-rod-side pressure chamber during the extending operation, that is, one flow path including the orifice and the other flow path including the communication path. On the other hand, the damper 10 has only one flow path of the hydraulic fluid from the counter-rod-side pressure chamber to the rod-side pressure chamber through the orifice during the contracting operation. Accordingly, the damping force generated by the damper 10 during the extending operation is smaller than the damping force generated by the damper 10 during the contracting operation.

As illustrated in FIG. 2, the abutting member 30 includes a top plate 32 which is configured to abut against the ceiling C at the time of installation of the furniture and two side plates 34A and 34B drooping from the top plate 32. The abutting member 30 is formed into a substantially plate shape and the shape of a box with an open lower side, as a whole. The top plate 32 of the abutting member 30 has the substantially same size as the upper wall 22 of the furniture body 20, for example. When the abutting member 30 is located at an initial position where each damper 10 is contracted, the abutting member 30 is disposed so that he top plate 32 covers an overall upper surface of the upper wall 22 as illustrated in FIG. 2.

In the furniture 1, two damper sets 7A and 7B are mounted on the abutting member 30 and the furniture body 20 as illustrated in FIG. 2. More specifically, the damper set 7A composed of a pair of dampers 10 is mounted on one widthwise side of the furniture body 20 and the abutting member 30 (the right side in a front view in the example of FIG. 2). The damper set 7B composed of a pair of dampers 10 is mounted on the other widthwise side of the furniture body 20 and the abutting member 30 (the left side in a front view in the example of FIG. 2).

As illustrated in FIG. 2, one side ends (upper ends) of the respective dampers 10 of the damper set 7A are coupled to the side plate 34A provided on one widthwise end of the abutting member 30, and one side ends (upper ends) of the respective dampers 10 of the damper set 7B are coupled to the side plate 34B provided on the other widthwise end of the abutting member 30. The upper ends of the dampers 10 of the damper set 7A are coupled so as to be rotatable relative to the side plate 34A about rotation axes extending in the width direction. In the damper set 7A, the damper 10A serves as an example of a front side damper and has a coupling position to the abutting member 30, which position is located ahead of a coupling position to the furniture body 20. Furthermore, the other damper 10B serves as an example of a rear side damper and has a coupling position to the abutting member 30, which position is located in the rear of a coupling position to the furniture body 20. More specifically, a coupling position of the damper 10A to the side plate 34A is located ahead of a coupling position of the damper 10B to the side plate 34A. The upper ends of the dampers 10 of the damper set 7B are coupled so as to be rotatable relative to the side plate 34B about rotation axes extending in the width direction. In the damper set 7B, too, the damper 10A serves as an example of a front side damper and has a coupling position to the abutting member 30, which position is located ahead of a coupling position to the furniture body 20. Furthermore, the other damper 10B serves as an example of a rear side damper and has a coupling position to the abutting member 30, which position is located in the rear of a coupling position to the furniture body 20. More specifically, a coupling position of the damper 10A to the side plate 34B is located ahead of a coupling position of the damper 10B to the side plate 34B. In any of the dampers 10, the coupling member 48 is inserted through the through hole 15A of the joint 15 provided on the upper end of the damper 10, so that the dampers 10 are fixed to the side plate 34A or 34B while being retained by the respective coupling members 48. The coupling member 48 consists of a bolt and is screwed into the side plate 34A or 34B to a predetermined depth thereby to be fixed, for example.

As illustrated in FIG. 2, the other side ends (lower ends) of the respective dampers 10 of the damper set 7A are coupled to the side wall 24A of the furniture body 20, and the other side ends (lower ends) of the respective dampers 10 of the damper set 7B are coupled to the side wall 24B of the furniture body 20. The lower ends of the dampers 10 of the damper set 7A are coupled so as to be rotatable relative to the side wall 24A. In the damper set 7A, a coupling position of the lower end of the damper 10A to the side wall 24A is identical with a coupling position of the lower end of the damper 10B to the side wall 24A with respect to the front-back direction, so that both dampers 10A and 10B are rotated about a common rotation axis. More specifically, the lower ends of the dampers 10 composing the damper set 7A are respectively provided with joints 15 connected to the bottom of the respective cylinders 11. A shaft member of the coupling member 44 is inserted through the through holes 15A formed in the respective joints 15. The coupling member 44 includes the shaft member inserted through the through holes 15A of the joints 15 and further into a through hole 42 of the side wall 24A thereby to be fixed, and a retainer disposed on an end of the shaft member located opposite the insertion side. FIG. 1 illustrates a section of the shaft member regarding the coupling member 44. More specifically, each through hole 42 may have a female screw structure, and the coupling member 44 may be a bolt and the like which is screwed into the through hole 42 to a predetermined depth. Furthermore, the structure should not be limited to the above-mentioned one, and any other structure may be adopted as long as the joint 15 does not come off from the coupling member 44 inserted into the through hole 42. In the damper set 7A, both dampers 10 are rotatably coupled to the side wall 24A with the above-described configuration so that the dampers 10 are rotatable along the planar direction perpendicular to the width direction.

The lower ends of the dampers 10 of the damper set 7B are coupled so as to be rotatable relative to the side wall 24B about the rotation axis extending in the width direction. In the damper set 7B, a coupling position of the lower end of the damper 10A to the side wall 24B is identical with a coupling position of the lower end of the damper 10B to the side wall 24B with respect to the front-back direction, so that both dampers 10A and 10B are rotated about a common rotation axis. More specifically, the lower ends of the dampers 10 composing the damper set 7B are respectively provided with joints 15. A shaft member of the coupling member 44 is inserted through the through holes 15A formed in the respective joints 15. The configuration to fix the lower ends of the dampers 10 of the damper set 7B to the side wall 24B is the same as the configuration to fix the lower ends of the dampers 10 of the damper set 7A to the side wall 24A.

Each of the damper sets 7A and 7B thus constructed has a distance increasing part in which a front-back distance between the dampers 10A and 10B becomes larger as coming close to the abutting member 30. As illustrated in FIG. 2, the substantially entire damper set 7A is constructed as a distance increasing part 9A. The lower ends of the respective dampers 10A and 10B overlap in the width direction, and a part above the overlapping part serves as a distance increasing part 9A. In the distance increasing part 9A, the front-back distance between the dampers 10A and 10B becomes larger as coming close to the abutting member 30. In the same manner, the substantially entire damper set 7B is constructed as a distance increasing part 9B. The lower ends of the respective dampers 10A and 10B overlap in the width direction, and a part above the overlapping part serves as the distance increasing part 9B. In the distance increasing part 9B, the front-back distance between the dampers 10A and 10B becomes larger as coming close to the abutting member 30.

The upper wall 22 of the furniture body 20 is formed with openings 22A and 22B extending therethrough in the up-down direction as illustrated in FIG. 2. The openings 22A and 22B are each formed into an elongated hole shape long in the front-back direction. The dampers 10 of the damper set 7A are coupled to an inner wall surface of the side wall 24A and inserted through the opening 22A of the upper wall 22, so that the dampers 10 straddle an interior and an exterior of the furniture body 20. The dampers 10 of the damper set 7B are coupled to an inner wall surface of the side wall 24B and inserted through the opening 22B of the upper wall 22, so that the dampers 10 straddle an interior and an exterior of the furniture body 20.

The furniture 1 further includes adjusters 40A and 40B adjusting coupling positions of the dampers 10 to the furniture body 20 (article body side adjuster). The adjuster 40A is provided at one widthwise side of the furniture body 20 to adjust the coupling positions of the dampers 10 of the damper set 7A (more specifically, levels at which the lower ends of the dampers 10 are attached). The adjuster 40B is provided at the other widthwise side of the furniture body 20 to adjust the coupling positions of the dampers 10 of the damper set 7B (more specifically, levels at which the lower ends of the dampers 10 are attached). Each of the adjusters 40A and 40B is composed of a plurality of through holes 42 lined in the up-down direction at intervals and the coupling member 44 inserted through one of the through holes 42 to be fixed.

The adjuster 40A is configured to be capable of changing the levels of the lower ends of the dampers 10 of the damper set 7A by switching the hole to which the coupling member 44 inserted into the lower ends of the damper set 7A is to be attached, among a plurality of the through holes 42 lined in the up-down direction. In the same manner, the adjuster 40B is configured to be capable of changing the levels of the lower ends of the dampers 10 of the damper set 7B by switching the hole to which the coupling member 44 inserted into the lower ends of the damper set 7B is to be attached, among a plurality of the through holes 42 lined in the up-down direction. Particularly in the present configuration, the paired dampers 10 are coupled to the furniture body 20 at the identical coupling position (the coupling position where the up-down positions and the front-back positions of both through holes 15A are identical), at either widthwise side. More specifically, the lower ends of the paired dampers 10 are coupled to the common coupling member 44. The through holes 15A of the dampers 10 through which the coupling member 44 is inserted are positioned so that the front-back positions and the up-down positions of the through holes 15A of the dampers 10 are identical. Thus, since the lower ends of the dampers 10 can be fixed by the common coupling member 44, this configuration can reduce the number of parts and costs and attachment/detachment of the dampers 10 can be rendered easier as compared with the configuration in which the lower ends of the dampers are respectively fixed by respective members.

When the furniture 1 thus constructed is to be installed, the abutting member 30 is firstly maintained near the initial position where the abutting member 30 is close to the furniture body 20 as illustrated by solid line in FIG. 1. In the present configuration, the position where the abutting member 30 is closest to the furniture body 20 is the initial position. In the example as illustrated in FIG. 1, the abutting member 30 comes into contact with the upper wall 22 of the furniture body 20 when located at the initial position. When the abutting member 30 is located at the initial position as illustrated in FIG. 1, all the dampers 10 become a contracted state. In this case, biasing forces to move the abutting member 30 upward are continuously applied by the dampers 10 to the abutting member 30. Accordingly, in order to maintain the abutting member 30 at the initial position, the furniture body 20 and the abutting member 30 need to be kept close to each other by the operation of an operator or by a tool. More specifically, a member such as string or wire may be fixed to the furniture body 20 and the abutting member 30 to maintain a narrow space therebetween, or the abutting member 30 may be maintained at the initial position by hand work of one or a plurality of operators. After the furniture 1 has been placed on the installation surface Fr with the abutting member 30 thus being disposed at the initial position, the abutting member 30 is released from the force applied to maintain the abutting member 30 at the initial position. Thereupon, the dampers 10 are extended by expansion forces of the compressed gas enclosed in the cylinders 11, with the result that the abutting member 30 can be caused to abut against the ceiling C as illustrated by two-dot chain line in FIG. 1.

As described above, the abutting member 30 is disposed between the furniture body 20 and the ceiling C at the time of installation of the furniture 1, and the furniture body 20 and the abutting member 30 are operated so as to move away from each other by the extension of the dampers 10 of the operating part 5. As a result, the furniture 1 can stably be installed while being placed on the installation surface Fr and pressing the ceiling C. Furthermore, since the dampers 10 are interposed between the furniture body 20 and the abutting member 30 while being coupled to the furniture body 20 and the abutting member 30, the damping force can be generated by the extending/contracting operation of the dampers 10 in accordance with shaking of the furniture body 20 or the abutting member 30 at the time of installation. Therefore, the shaking of the furniture body 20 and the abutting member 30 can be suppressed, with the result that overturn preventing effect can be enhanced. Moreover, the furniture body 20, the abutting member 30, the dampers 10 and the like are coupled integrally in the furniture 1, and these can be managed in an integrated manner, with the result that management burdens can be reduced. Furthermore, since the dampers 10 can be previously coupled to the furniture body 20 and the abutting member 30 thereby to be positioned before installation of the furniture 1, work burdens of mounting, positioning etc. of the dampers 10 to the furniture body 20 can be reduced.

Accordingly, the overturn preventing function can be added to the article itself, and work burdens and management burdens at the time of mounting can be reduced.

The furniture 1 in the present configuration includes the dampers 10A (the front side dampers) mounted to be inclined to one front-back side (the shorter side direction in the planar view of the furniture body 20) and the dampers 10B (the rear side dampers) mounted to be inclined to the other front-back side. According to this configuration, even when the furniture body 20 is tilted in the one front-back side or tilted in the other front-back side, the force tilting the furniture body 20 can effectively be damped with the result that the tilt of the furniture body 20 can be suppressed. In particular, in the case of the structure of the furniture body 20, the furniture 1 is more likely to be tilted in the front-back direction (the shorter side direction in the planar view) than in the width direction. In the present configuration, however, since the one side dampers 10A and the other side dampers 10B are disposed so as to be inclined frontward and backward, respectively, the force tilting the furniture body 20 can effectively be damped even when the furniture body 20 is tilted to either side in the front-back direction (the direction in which the furniture body 20 is easily overturned).

Though the above-described advantageous effect can be achieved when the furniture body 20 is installed adjacent to the wall W, as illustrated in FIG. 1, the effect is noticeable particularly when the furniture body 20 is not adjacent to an external wall, that is, when installed in a non-adjacent state. When placed in a non-adjacent state, a piece of conventional general furniture has a possibility of being tilted to both one side and the other side of an overturning direction (a direction in which the furniture in a placed state is easily overturned) since the furniture is not supported by any external wall, with the result that the furniture had to be placed in an unstable state. Even if it is attempted to stabilize the furniture by mounting an overturn preventing device as disclosed by aforementioned Patent Document 1, the conventional overturn preventing device was not able to cope with overturn in both directions and therefore was difficult to apply since the device is configured to cope only with overturn of the furniture to one side. However, in the case where the furniture 1 of the present configuration is installed in the non-adjacent state, a damping force is generated not only when the furniture 1 is tilted to one side but also when tilted to the other side in the overturning direction (the front-back direction in which the furniture in a placed state is easily overturned), with the result that stable installation becomes possible.

In the furniture 1 of the present configuration, the damper sets 7A and 7B each of which includes a pair of the dampers 10 are respectively mounted at both widthwise sides of the furniture body 20. The damper sets 7A and 7B are provided with respective distance increasing parts 9A and 9B in which the front-back distance between the dampers 10A and 10B becomes larger as coming close to the abutting member 30. According to this configuration, both widthwise sides of the abutting member 30 can be supported at a plurality of positions when the abutting member 30 is operated to be moved away from the furniture body 20. Furthermore, since forces from the dampers 10 act on both the front side and the rear side at both widthwise sides of the abutting member 30, the forces applied to the abutting member 30 from the dampers 10 can be restrained from being excessively biased to one of the sides in the front-back direction.

In the furniture 1 of the present configuration, the coupling position of the damper 10A to the abutting member 30 is located ahead of the coupling position of the damper 10B to the abutting member 30 in each of the damper sets 7A and 7B. The coupling position of the damper 10A to the furniture body 20 is identical with the coupling position of the damper 10B to the furniture body 20 with respect to the front-back direction. Thus, when the damper sets 7A and 7B are mounted so that the dampers 10A and 10B cross (the state in which at least parts of the dampers overlap), the abutting member 30 can be supported while the one side dampers 10A are more inclined to one side in the front-back direction and the other dampers 10B are more inclined to the other side in the front-back direction.

In the furniture 1 of the present configuration, the furniture body 20 includes the sidewalls 24A and 24B and the upper wall 22. The upper wall 22 is formed with the openings 22A and 22B penetrating therethrough in the up-down direction. The dampers 10 are each coupled to the inner wall side of either the sidewalls 24A or 24B and inserted through either the openings 22A or 22B thereby to be disposed. According to this configuration, the interior of the furniture body 20 can be used as an arrangement space of the dampers 10. And at the time when the dampers 10 are contracted, the abutting member 30 can be caused to come closer to the furniture body 20 thereby to be disposed more compactly.

In the furniture 1 of the present configuration, the dampers 10 are respectively coupled to both widthwise ends of the furniture body 20. When the dampers 10 are thus mounted so as to be largely separated from each other in the width direction, a wide region between the dampers disposed at both widthwise sides can be ensured in the region between the abutting member 30 and the furniture body 20 at the time of installation of the article. As a result, the region which is thus widely ensured can effectively be used as a storage space and the like.

In the furniture 1 of the present configuration, a plurality of the dampers 10 is coupled to the furniture body 20 at the identical coupling position at both widthwise sides of the furniture 1. The furniture 1 includes the adjusters 40A and 40B (article-side adjusters) which adjust the coupling positions of the dampers 10 in the furniture body 20. According to this configuration, the coupling positions of the dampers 10 in the furniture body 20 can be set at more desirable coupling positions according to the surroundings in which the article is to be installed. Moreover, since a plurality of the dampers 10 is coupled at the identical coupling position in any position adjusted by the adjuster 40A or 40B, the number of parts can be reduced and workability can be improved as compared with the configuration in which the dampers are adjusted to be positioned and fixed individually.

More specifically, the levels of the lower ends of the dampers 10 can be adjusted by the adjusters 40A and 40B (the article-side adjusters). Accordingly, a suitable level range of the abutting member 30 can be switched according to a distance between the installation surface and the ceiling without preparing a number of dampers having different lengths.

### Second Embodiment

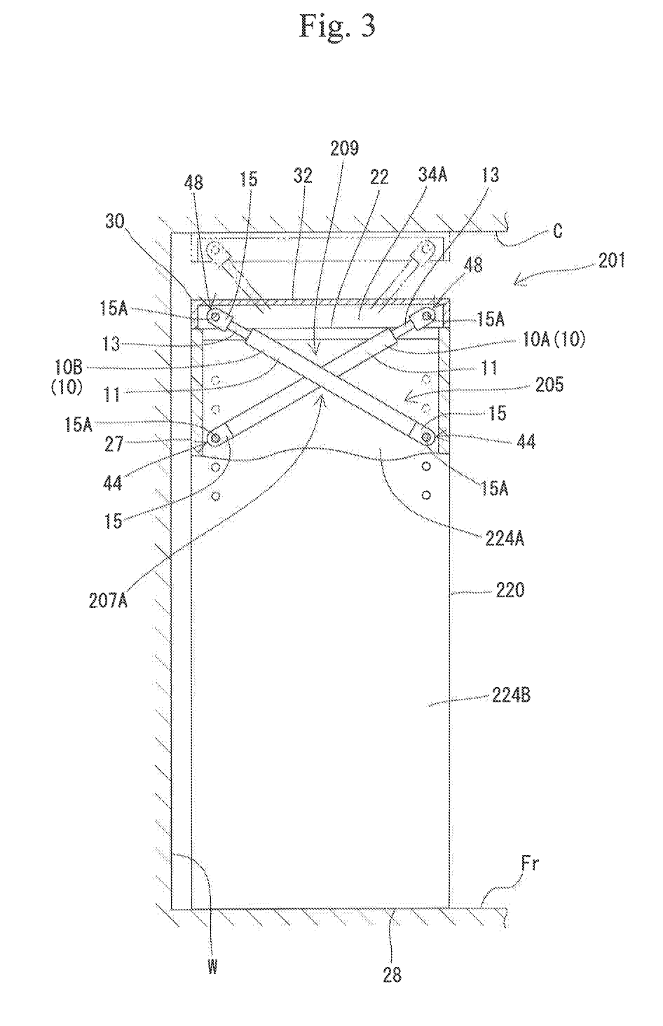

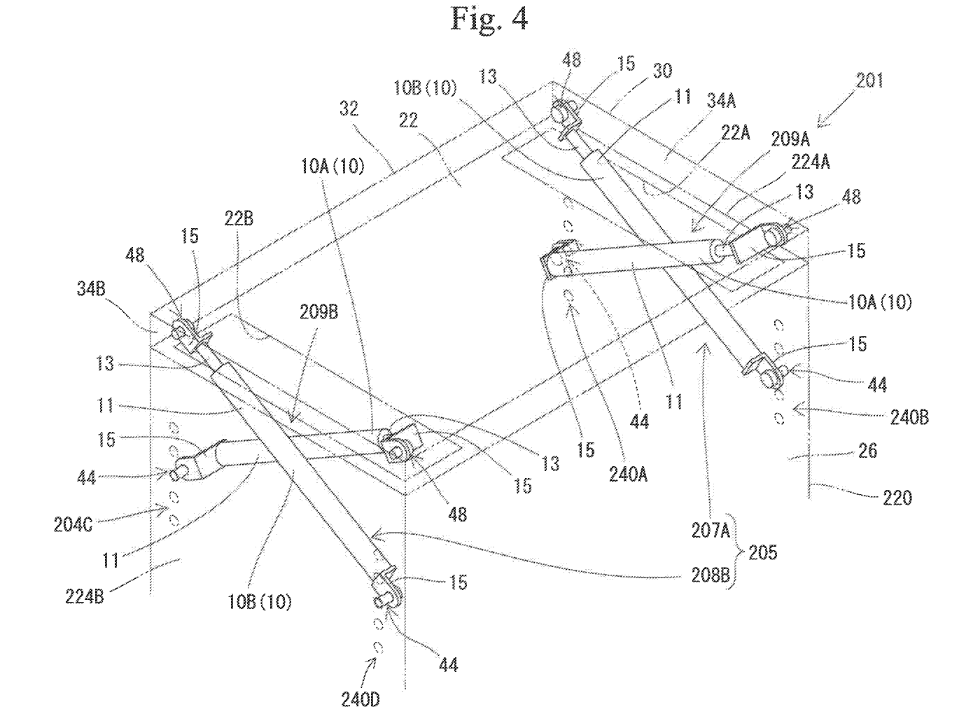

Next, a second embodiment will be described with reference to FIGS. 3, 4 and the like. In a piece of furniture 201 of the second embodiment as illustrated in FIGS. 3 and 4, configurations of operating part 205, adjusters 240A, 240B, 240C and 240D and sidewalls 224A and 224B differ from the configurations of the operating part 5, the adjusters 40A and 40B and the sidewalls 24A and 24B in the first embodiment. Other parts in the second embodiment have the same configurations and functions as those in the first embodiment. Accordingly, identical or similar parts in the second embodiment are labelled by the same reference symbols as those in the first embodiment, and detailed description of these parts will be eliminated.

The furniture 201 of the second embodiment includes the furniture body 220 disposed between the installation surface Fr and the ceiling C at the time of installation, the plate-like abutting member 30 disposed between the ceiling C and the furniture body 220 at the time of installation, and the operating part 205. The furniture 201 serves as an example of the article equipped with the overturn preventing device in accordance with the invention. The operating part 205 has a plurality of dampers 10. One of two ends of each damper 10 is coupled to the furniture body 220, and the other end of each damper 10 is coupled to the abutting member 30. Each damper 10 has the same structure as that of the first embodiment. The operating part 205 is configured such that the dampers 10 become the contracted state when the abutting member 30 is disposed at the initial position near the furniture body 220 side, as illustrated by solid line in FIG. 3. The operating part 205 is operated such that the abutting member 30 is moved to the developed position upwardly farther away from the furniture body 220 than the initial position according to extension of the dampers 10 thereby to be caused to abut against the ceiling C, as illustrated by two-dot chain line in FIG. 3.

In the furniture 201, two damper sets 207A and 207B are mounted on the abutting member 30 and the furniture body 220 as illustrated in FIGS. 3 and 4. More specifically, the damper set 207A composed of a pair of dampers 10 is mounted on one widthwise side of the furniture body 220 and the abutting member 30 (the right side in a front view in the example of FIG. 4). The damper set 207B composed of a pair of dampers 10 is mounted on the other widthwise side of the furniture body 220 and the abutting member 30 (the left side in the front view in the example of FIG. 4).

As illustrated in FIG. 4, one side ends (upper ends) of the respective dampers 10 of the damper set 207A are rotatably coupled to the side plate 34A provided on one widthwise end of the abutting member 30, and one side ends (upper ends) of the respective dampers 10 of the damper set 207B are rotatably coupled to the side plate 34B provided on the other widthwise end of the abutting member 30. The other side ends (lower ends) of the respective dampers 10 of the damper set 207A are coupled to the side wall 224A of the furniture body 220, and the other side ends (lower ends) of the respective dampers 10 of the damper set 207B are coupled to the side wall 224B of the furniture body 220. In the damper set 207A, the coupling position of the one side damper 10A to the side plate 34A is located ahead of the coupling position of the other side damper 10B to the side plate 34A. And the coupling position of the one side damper 10A to the side wall 224A is located in the rear of the coupling position of the other side damper 10B to the side wall 224A. In other words, the damper set 207A is constructed such that one side damper 10A and the other side damper 10B intersect with each other as viewed in a side view. In the damper set 207B, the coupling position of the one side damper 10A to the side plate 34B is located ahead of the coupling position of the other side damper 10B to the side plate 34B. And the coupling position of the one side damper 10A to the side wall 224B is located in the rear of the coupling position of the other side damper 10B to the side wall 224B. In other words, the damper set 207B is also constructed such that one side damper 10A and the other side damper 10B intersect with each other as viewed in a side view.

In the damper set 207A, the cylinder 11 of the damper 10A and the cylinder 11 of the other damper 10B partially overlap in the width direction, and a part located above the overlapping part serves as a distance increasing part 209A. In the distance increasing part 209A, the front-back distance between the damper 10A and the damper 10B becomes larger as coming close to the abutting member 30. In the same manner, in the damper set 207B, the cylinder 11 of the damper 10A and the cylinder 11 of the other damper 10B partially overlap in the width direction, and a part located above the overlapped part serves as a distance increasing part 209B. In the distance increasing part 209B, the front-back distance between the damper 10A and the damper 10B becomes larger as coming close to the abutting member 30.

The adjuster 240A is configured to be capable of changing the level of the lower end of the one side damper 10A of the damper set 207A by switching the hole to which the coupling member 44 inserted into the lower end of the damper 10A of the damper set 7A is to be attached, among a plurality of the through holes lined in the up-down direction. The adjuster 240B is configured to be capable of changing the level of the lower end of the other side damper 10B of the damper set 207A by switching the hole to which the coupling member 44 inserted into the lower end of the damper 10B of the damper set 7A is to be attached, among a plurality of the through holes lined in the up-down direction. The adjuster 240C is configured to be capable of changing the level of the lower end of the one side damper 10A of the damper set 207B by switching the hole to which the coupling member 44 inserted into the lower end of the damper 10A of the damper set 7B is to be attached, among a plurality of the through holes lined in the up-down direction. The adjuster 240D is configured to be capable of changing the level of the lower end of the one side damper 10B of the damper set 207B by switching the hole to which the coupling member 44 inserted into the lower end of the damper 10B of the damper set 7B is to be attached, among a plurality of the through holes lined in the up-down direction.

When the furniture 201 of the present configuration is to be installed, too, the abutting member 30 is maintained near the initial position where the abutting member 30 is close to the furniture body 20, and in this state, the furniture 1 is placed on the installation surface Fr. Subsequently, when the abutting member 30 is released from the force applied to maintain the abutting member 30 at the initial position, the dampers 10 are extended by the expansion force of the compressed gas enclosed in the cylinders 11, with the result that the abutting member 30 can be caused to abut against the ceiling C as illustrated by two-dot chain line in FIG. 3. The above-described configuration of the furniture 201 can also achieve the same effect as the furniture 1 of the first embodiment.

### Third Embodiment

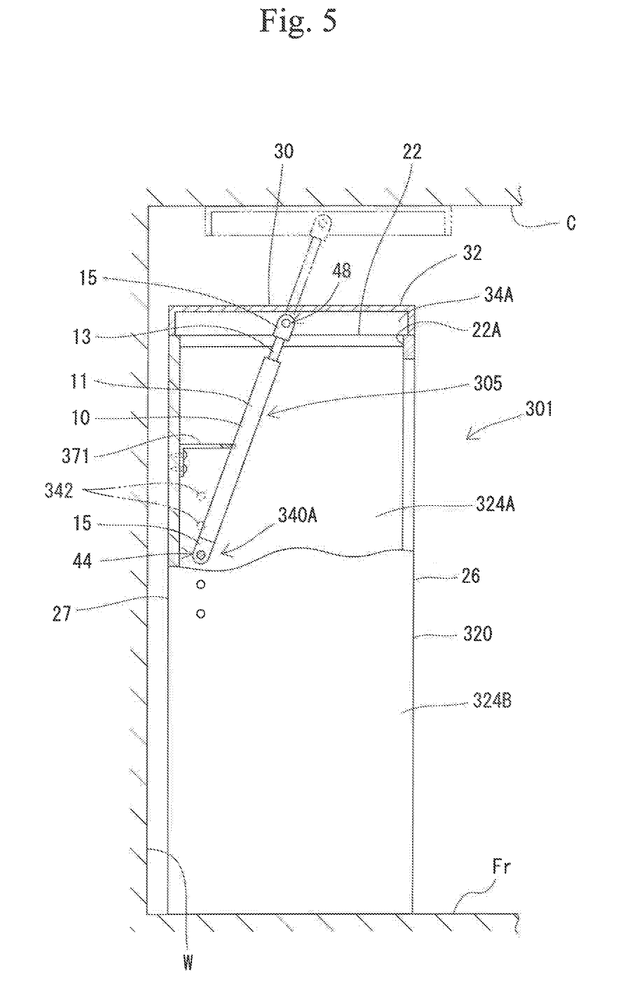

Next, a third embodiment will be described with reference to FIGS. 5 to 8, etc. A piece of furniture 301 of the third embodiment as illustrated in FIG. 5 and the like differs from the furniture 1 of the first embodiment in that the operating part 5 has been changed to an operating part 305, that angle regulating parts 371 and 372 are provided, and that the through holes 42 have been changed to through holes 342. The third embodiment is the same as the first embodiment in the other respects. Accordingly, identical or similar parts in the third embodiment are labelled by the same reference symbols as those in the furniture 101 of the first embodiment and detailed description of these parts will be eliminated.

As illustrated in FIGS. 5 to 7, the furniture 301 of the third embodiment includes the furniture body 320 disposed between the installation surface Fr and the ceiling C at the time of installation, the plate-like abutting member 30 disposed between the ceiling C and the furniture body 320 at the time of installation, and the operating part 305. The operating part 305 has a plurality of dampers 10. One of two ends of each damper 10 is coupled to the furniture body 320, and the other end of each damper 10 is coupled to the abutting member 30. Each damper 10 has the same structure as that of the first embodiment. The operating part 305 is configured such that the dampers 10 become the contracted state when the abutting member 30 is disposed at the initial position near the furniture body 320 side, as illustrated by solid line in FIG. 5. The operating part 305 is operated such that the abutting member 30 is moved to the developed position upwardly farther away from the furniture body 320 than the initial position according to extension of the dampers 10 thereby to be caused to abut against the ceiling C, as illustrated by two-dot chain line in FIG. 5.

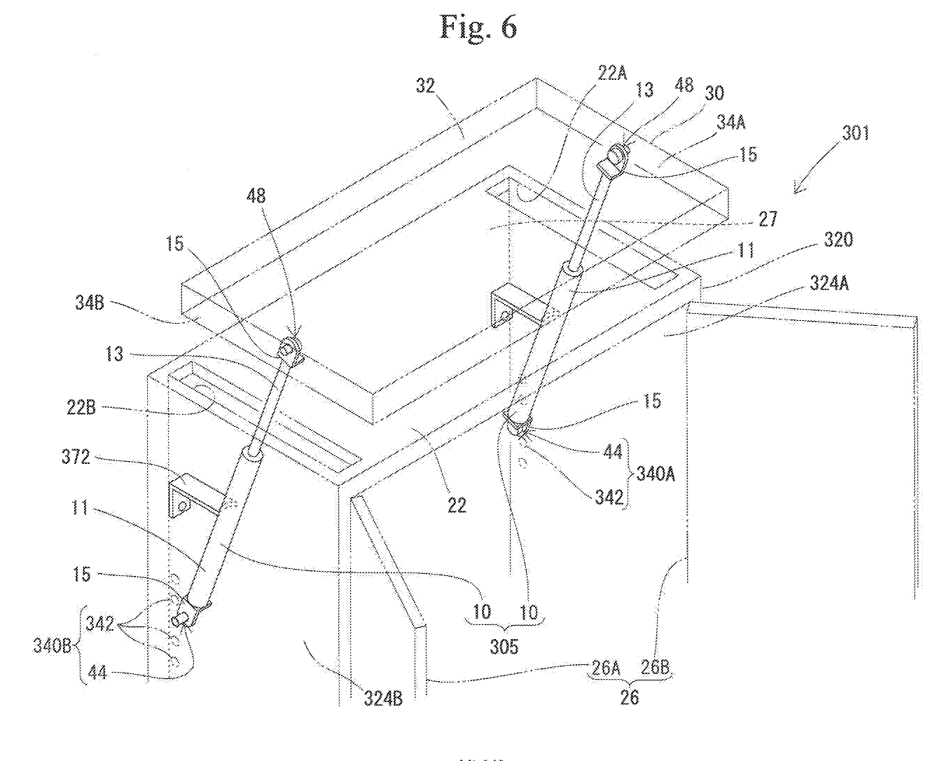

The furniture body 320 has the same configuration as the furniture body 20 in the first embodiment except for the sidewalls 324A and 324B. As illustrated in FIG. 6, the upper wall 22 of the furniture body 320 has openings 22A and 22B which are respectively formed in both widthwise sides thereof to extend through the upper wall 22 in the up-down direction and to be formed as an elongated hole structure extending in the front-back direction. In the furniture body 320 as illustrated in FIG. 6, a structure of a front surface 26 is specified. In this example, the front surface 26 is constructed as doors 26A and 26B which open and close an opening part (a part which is open frontward) formed in the front of the furniture body 320.

As illustrated in FIG. 6, two dampers 10 are respectively coupled to both widthwise ends of the furniture body 320 and the abutting member 30. One end (upper end) of one of the dampers 10 is rotatably coupled to the side plate 34A provided at one widthwise side of the abutting member 30. The other end (lower end) of the damper 10 is rotatably coupled to the inner wall surface side of the sidewall 324A of the furniture body 20. One end (upper end) of the other of the dampers 10 is rotatably coupled to the side plate 34B provided at the other widthwise side of the abutting member 30. The other end (lower end) of the damper 10 is rotatably coupled to the inner wall surface side of the sidewall 324B of the furniture body 20

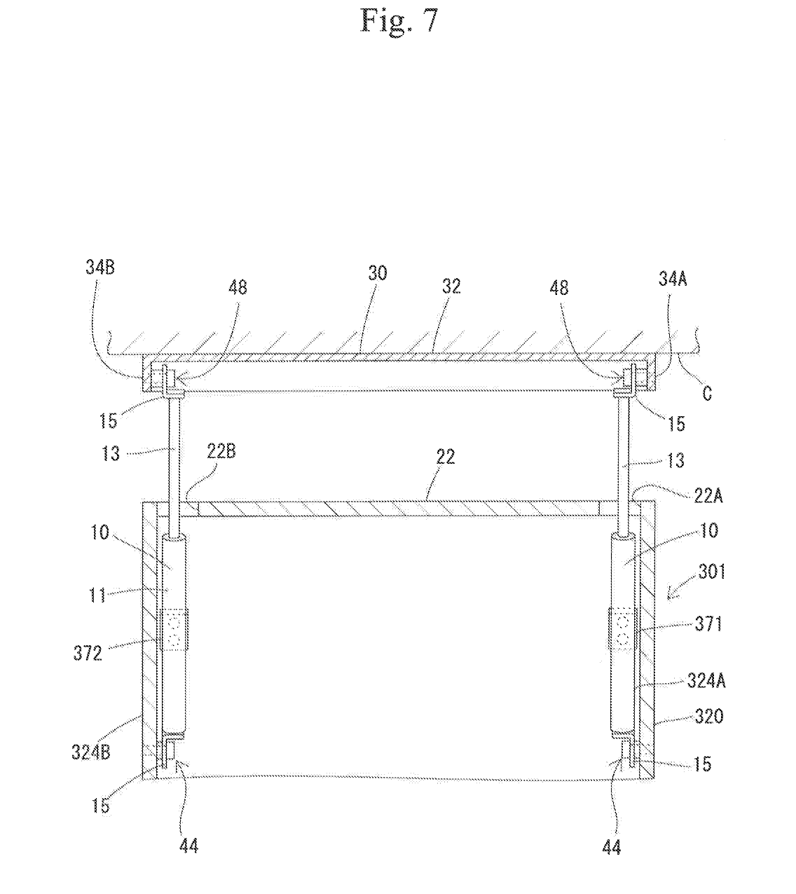

As illustrated in FIGS. 6 and 7, the damper 10 coupled to the side plate 34A and the sidewall 324A is inserted through the opening 22A of the upper wall 22 thereby to be disposed across an interior and an exterior of the furniture body 320. The damper 10 coupled to the side plate 34B and the sidewall 324B is inserted through the opening 22B of the upper wall 22 thereby to be disposed across the interior and the exterior of the furniture body 320.

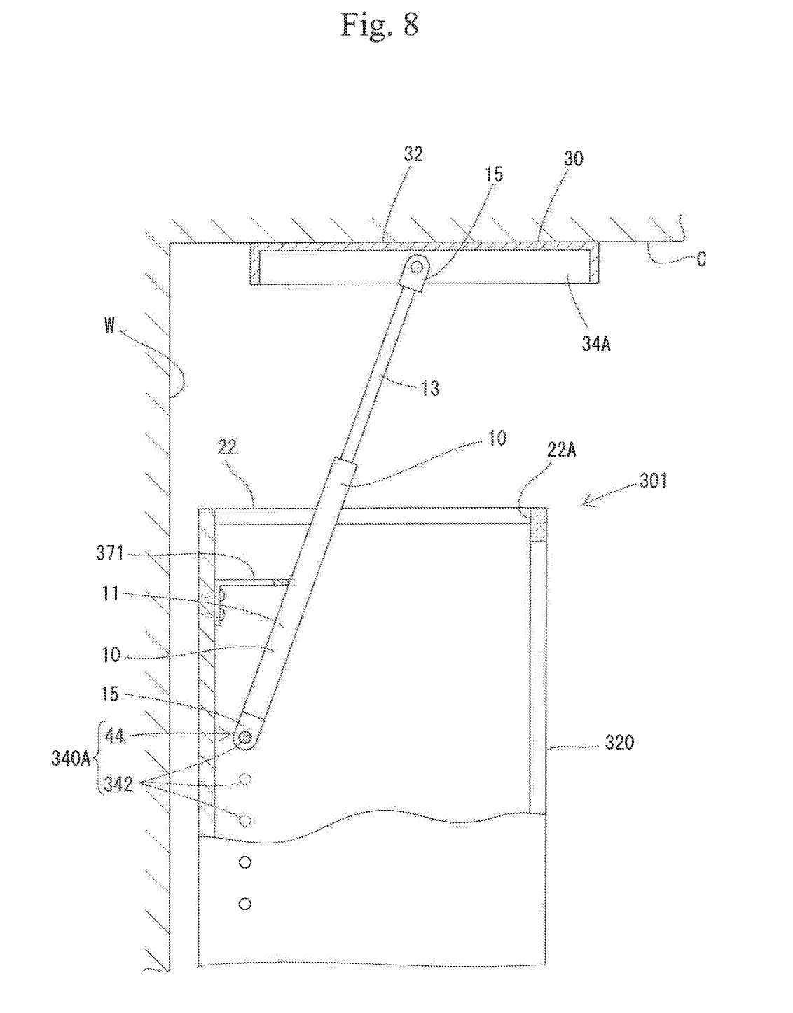

The furniture 301 is also provided with the adjusters 340A and 340B (article body side adjuster) which adjust the coupling position of the lower end of each damper 10 in the furniture body 320. Each of the adjusters 340A and 340B is composed of a plurality of through holes 342 lined in the up-down direction at intervals and the coupling member 44 inserted through one of the through holes 342 to be fixed. The adjuster 340A is configured to be capable of changing the level of the lower end of the one widthwise side damper 10 by switching the hole to which the coupling member 44 inserted into the lower end of the damper 10 is to be attached, among a plurality of the through holes 342 lined in the up-down direction. The adjuster 340B is configured to be capable of changing the level of the lower end of the other widthwise side damper 10 by switching the hole to which the coupling member 44 inserted into the lower end of the damper 10 is to be attached, among a plurality of the through holes 342 lined in the up-down direction. For example, in the example as illustrated in FIGS. 5 and 6, the damper 10 is mounted so that the coupling member 44 inserted into the lower end of the damper 10 is fixed in the third hole from the top in each of the adjusters 340A and 340B. On the other hand, in the example as illustrated in FIG. 8, the damper 10 is mounted so that the coupling member 44 inserted into the lower end of the damper 10 is fixed in the top through hole 342, whereby the lower end of the damper 10 is disposed higher than in the configuration of FIGS. 5 and 6.

As illustrated in FIGS. 6 and 7, the furniture 301 is provided with angle regulators 371 and 372 respectively regulating inclination angles of the dampers 10 disposed at both widthwise sides, so that the dampers 10 at both widthwise sides can be disposed at respective desired inclination angles. The angle regulator 371 at one widthwise side is fixed to the back surface 27 so as to extend frontward from an inner wall surface of the back surface 27 in the rear of the one widthwise side damper 10. The angle regulator 371 abuts against the one widthwise side damper 10 when an inclination angle of the damper 10 with respect to the up-down direction reaches an allowable minimum angle, thereby preventing the damper 10 from being raised further. Although the damper 10 is rotated about the shaft member of the coupling member 44 around the widthwise rotation axis, the inclination angle of the damper 10 with respect to the up-down direction is regulated so as to be not less than the above-mentioned minimum angle. Furthermore, the one widthwise side damper 10 abuts against the front end of the opening 22A when the inclination angle thereof with respect to the up-down direction reaches a predetermined maximum angle, thereby being prevented from further inclination.

In the same manner, the angle regulator 372 at the other widthwise side is fixed to the back surface 27 so as to extend frontward from the inner wall surface of the back surface 27 in the rear of the other widthwise side damper 10. The angle regulator 371 abuts against the other widthwise side damper 10 when the inclination angle of the damper 10 with respect to the up-down direction reaches an allowable minimum angle, thereby preventing the damper 10 from being raised further. Although the damper 10 is rotated about the shaft member of the coupling member 44 around the widthwise rotation axis, the inclination angle of the damper 10 with respect to the up-down direction is regulated so as to be not less than the above-mentioned minimum angle. Furthermore, the other widthwise side damper 10 abuts against the front end of the opening 22B when the inclination angle thereof with respect to the up-down direction reaches a predetermined maximum angle, thereby being prevented from further inclination. Thus, the inclination angles of both widthwise side dampers 10 are regulated so that the inclination angles with respect to the up-down direction fall within the range from the above-mentioned minimum angle to the above-mentioned maximum angle.

When the furniture 301 of the present configuration is to be installed, too, the abutting member 30 is maintained near the initial position where the abutting member 30 is close to the furniture body 20 and in this state, the furniture 1 is placed on the installation surface Fr. Subsequently, when the abutting member 30 is released from the force applied to maintain the abutting member 30 at the initial position, the dampers 10 are extended by the expansion force of the compressed gas enclosed in the cylinders 11, with the result that the abutting member 30 can be caused to abut against the ceiling C as illustrated by two-dot chain line in FIG. 5.

The above-described configuration of the furniture 301 can also add the overturn preventing function to the article itself and can reduce work burdens and management burdens at the time of mounting. Furthermore, when the two dampers 10 are respectively provided on both widthwise sides of the furniture body 320 and configured to be inclined frontward, as the furniture 301 illustrated in FIGS. 5 to 8, it is desirable to install the furniture 301 while the back surface 27 is adjacent to the wall W. As the result of this manner of installation, the furniture body 320 can be prevented from being overturned backward, and the frontward overturn of the furniture body 320 can be damped by both dampers 10, so that a more stable installed condition can be achieved.

### Fourth Embodiment

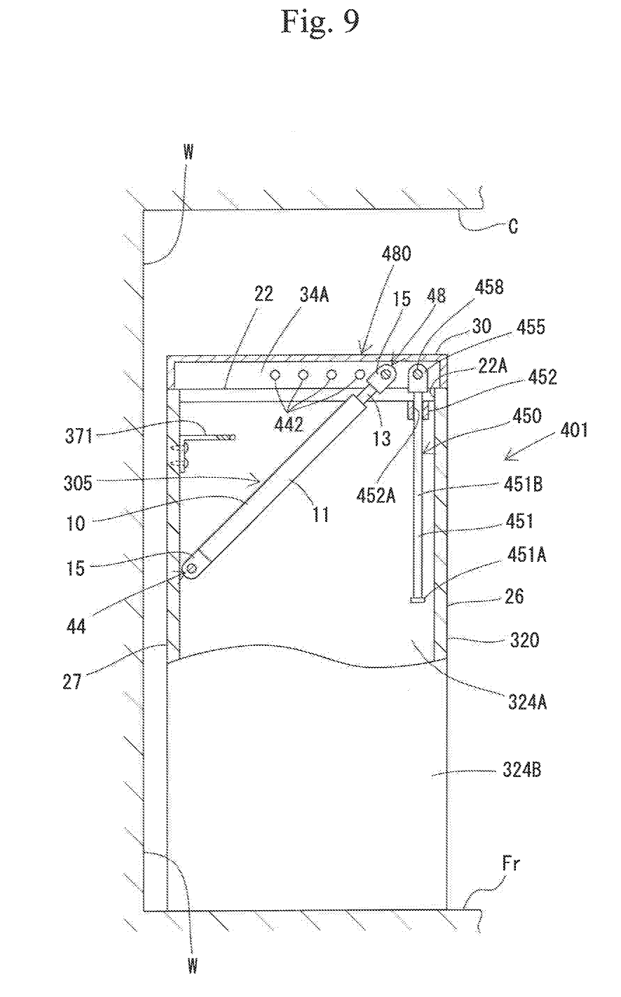

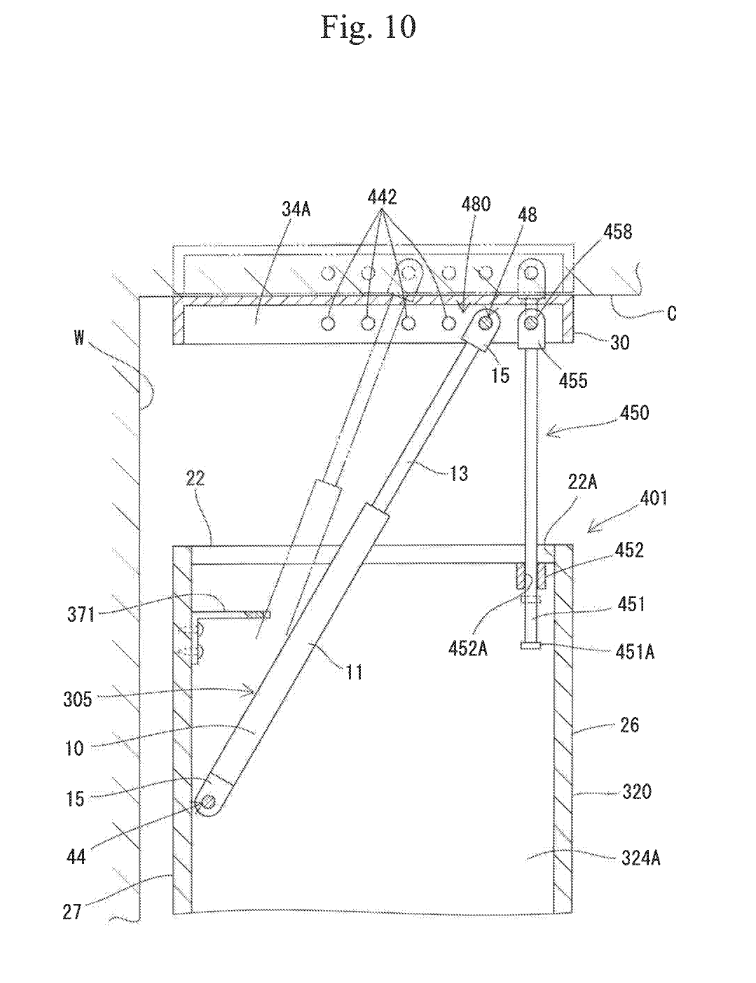

Next, a fourth embodiment will be described with reference to FIGS. 9, 10, etc. A piece of furniture 401 of the fourth embodiment as illustrated in FIG. 9 and the like includes an entire configuration of the third embodiment, and a new configuration is added. More specifically, a guide 450 and a distance limiter 451A and an adjuster 480 are added with respect to the furniture 301 of the third embodiment illustrated in FIG. 5 and the like. Accordingly, identical or similar parts in the furniture 401 are labelled by the same reference symbols as those in the furniture 301 of the third embodiment and detailed description of these parts will be eliminated.

As illustrated in FIG. 9, the furniture 401 of the fourth embodiment includes the furniture body 320 disposed between the installation surface Fr and the ceiling C at the time of installation, the plate-like abutting member 30 disposed between the ceiling C and the furniture body 320 at the time of installation, the operating part 305, and the angle regulators. The furniture body 320, the abutting member 30, and the operating part 305 respectively have the same configurations as in the third embodiment and function in the same manners as in the third embodiment. Although FIG. 9 illustrates only one angle regulator 371, the furniture 401 includes the same configuration of the angle regulators 371 and 372 as illustrated in FIG. 6. The operating part 305 is constructed in the same manner as in FIG. 6 and has a plurality of dampers 10. Each damper 10 has two ends one of which is coupled to the furniture body 320 and the other of which is coupled to the abutting member 30. Each damper 10 has the same structure as in the first embodiment. The operating part 305 is configured such that the dampers 10 become the contracted state when the abutting member 30 is disposed at the initial position near the furniture body 320 side as illustrated in FIG. 9. The operating part 305 is operated such that the abutting member 30 is moved to the developed position upwardly farther away from the furniture body 320 than the initial position according to extension of the dampers 10 thereby to be caused to abut against the ceiling C, as illustrated in FIG. 10.

As illustrated in FIG. 9, the furniture 401 includes a guide 450 which limits a range of horizontal movement of the abutting member 30 during extension/contraction of the dampers 10. The guide 450 includes a linearly extending bar-like shaft member 451 and a guide part 452 to guide the shaft member 451 in the up-down direction. The shaft member 451 has an upper end provided with a joint 455 which is similar to the joint 15. The joint 455 is rotatably coupled to the side plate 34A of the abutting member 30. The shaft member 451 has a lower end provided with a flange-like distance limiter 451A projecting outside a body 451B of the shaft member 451 (a part fitted into a through hole 452A which will be described later).

The guide 452 is fixed to an inner wall surface of the side wall 324 of the furniture body 320 and formed with the through hole 452A extending in the up-down direction. the through hole 452A is slidably fitted with the body 451B of the shaft member 451 to guide the body 451B in the up-down direction while the long side direction of the body 451B is maintained in the up-down direction.

In the guide 450 thus configured, the shaft member 451 is moved up and down while the positions of the shaft member 451 in the front-back direction and in the width direction are retained by the guide part 452. As a result, the abutting member 30 coupled to the shaft member 451 is guided up and down while the positions of the abutting member 30 in the front-back direction and in the widthwise position are retained (in other words, while the horizontal movement is prevented).

Since the furniture 401 has the above-described guide 450, the abutting member 30 is disposed without being largely deviated from the furniture body 320 in the horizontal direction when the dampers 10 are contracted, with the result that the furniture 401 can be rendered more compact. Furthermore, when the dampers 10 are extended, the abutting member 30 can be moved away from the furniture body 320 without being largely deviated from the furniture body 320 in the horizontal direction.

When the shaft member 451 is moved to an allowable maximum height, the flange-like distance limiter 451A abuts against a lower end of the guide 452 thereby to prevent the shaft member 451 from further moving upward and the abutting member 30 from further moving upward. Thus, the distance limiter 451A prevents the distance between the abutting member 30 and the furniture body 320 from being increased in excess of a previously set maximum distance. Consequently, the distance can be kept not more than the maximum distance, with the result that failure due to exceeding the maximum distance (for example, the damper is excessively extended into a state such that a damping force is not generated) can be prevented.

As illustrated in FIG. 9, the furniture 401 is provided with the adjusting section 480 (abutting member side adjusting section) which adjusts the coupling position of each damper 10 to the abutting member 30. The adjuster 480 includes a plurality of through holes 442 lined in the front-back direction at intervals and a coupling member 48 inserted through one of the through holes 442 to be fixed. The adjuster 480 is configured be capable of changing the position of the upper end of the damper 10 in the front-back direction by switching the hole to which the coupling member 48 inserted into the upper end of the damper 10 is to be attached, among a plurality of the through holes 442 lined in the front-back direction. As a result, the level of the upper end of the damper 10 can be changed.

For example, in the example illustrated by solid line in FIG. 10, the damper 10 is mounted so that the coupling member 48 inserted into the upper end of the damper 10 is fixed in the foremost through hole 442. On the other hand, in the example illustrated by two-dot chain line, the mounting position is changed so that the coupling member 48 inserted into the upper end of the damper 10 is fixed in the third foremost through hole 442. Although, in the example illustrated by two-dot chain line, the rod 13 extends as long as in the example illustrated in the solid line, the upper end of the damper 10 is located higher since the damper 10 is raised more. Thus, the level of the upper end of the damper 10 can be adjusted and the level of the abutting member 30 can be adjusted. As a result, the suitable level range of the abutting member 30 can be more easily adjusted to a more desirable range according to surroundings in which the furniture is installed.

Although the configuration at one widthwise side is illustrated as an example in FIGS. 9 and 10, the other widthwise side is configured in the same manner. In other words, through holes which are the same as the through holes 442 are formed to be lined in the front-back direction in the side plate 34B at the other widthwise side (refer to FIGS. 6, 7 and the like), and an adjuster which is the same as the adjuster 480 is constructed. The mounting position of the upper end of the other widthwise side damper 10 (refer to FIGS. 6, 7 and the like) is switchable. Furthermore, a guide which is the same as the guide 450 is provided also at the other widthwise side, so that the horizontal movement of the abutting member 30 is prevented also at the other widthwise side. The configuration of the furniture 401 as described above can also achieve the same advantageous effect as the furniture 301 of the third embodiment.

### Fifth Embodiment

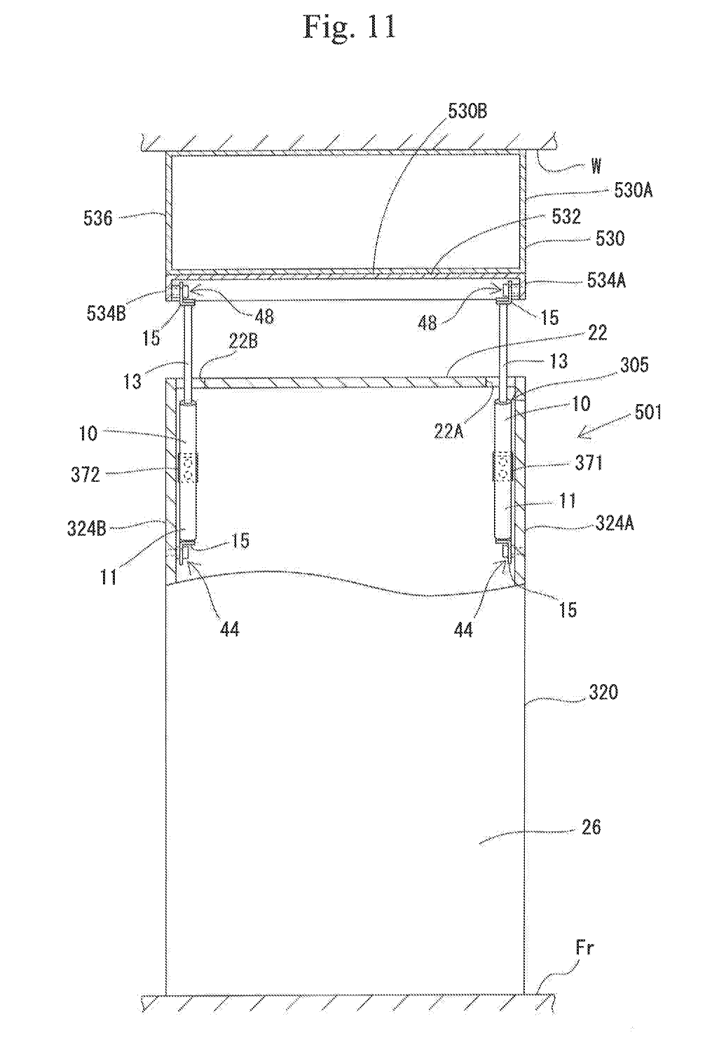

Next, a fifth embodiment will be described with reference to FIG. 11 and the like. A piece of furniture 501 of the fifth embodiment as illustrated in FIG. 11 and the like differs only in the configuration of an abutting member 530 from the abutting member 30 of the third embodiment. The configurations other than the abutting member are the same as those of the third embodiment in the other respects. Accordingly, the parts other than the abutting member in the fifth embodiment are labelled by the same reference symbols as those in the third embodiment and detailed description of these parts will be eliminated.

As illustrated in FIG. 11, the furniture 501 of the fifth embodiment includes the furniture body 320 disposed between the installation surface Fr and the ceiling C at the time of installation, the box-like abutting member 530 disposed between the ceiling C and the furniture body 320 at the time of installation, the operating part 305, and the angle regulators 371 and 372. The furniture body 320, the operating part 305 and the angle regulators 371 and 372 respectively have the same configurations as in the third embodiment and function in the same manners as in the third embodiment. The operating part 305 is configured in the same manner as in FIG. 6 and has a plurality of dampers 10. Each damper 10 has two ends one of which is coupled to the furniture body 320 and the other of which is coupled to the abutting member 530. Each damper 10 has the same structure as in the first embodiment. The operating part 305 is configured such that the dampers 10 become the contracted state when the abutting member 530 is disposed at the initial position near the furniture body 320 side. The operating part 305 is operated such that the abutting member 530 is moved to the developed position upwardly farther away from the furniture body 320 than the initial position according to extension of the dampers 10 thereby to be caused to abut against the ceiling C, as illustrated in FIG. 11.

In the furniture 501 of the fifth embodiment, the abutting member 530 has a box-shaped part 530A formed into a box shape. The box-shaped part 530A is structured so that for example, a front thereof is always open or openable/closable, whereby an interior of the box-shaped part 530A is constructed as a housing space. In the abutting member 530, the box-shaped part 530A has a bottom on which a member 530B having the same configuration as the abutting member 30 in the third embodiment is provided. The member 530B has a plate-shaped part 532 which is the same as the top plate 32 (FIG. 7) and side plates 534A and 534B which are the same as the side plates 34A and 34B. The side plates 534A and 534B are respectively coupled to two dampers in the same manner as in the third embodiment. The configuration of the furniture 501 as described above can also achieve the same advantageous effect as the furniture 301 of the third embodiment.

### Sixth Embodiment

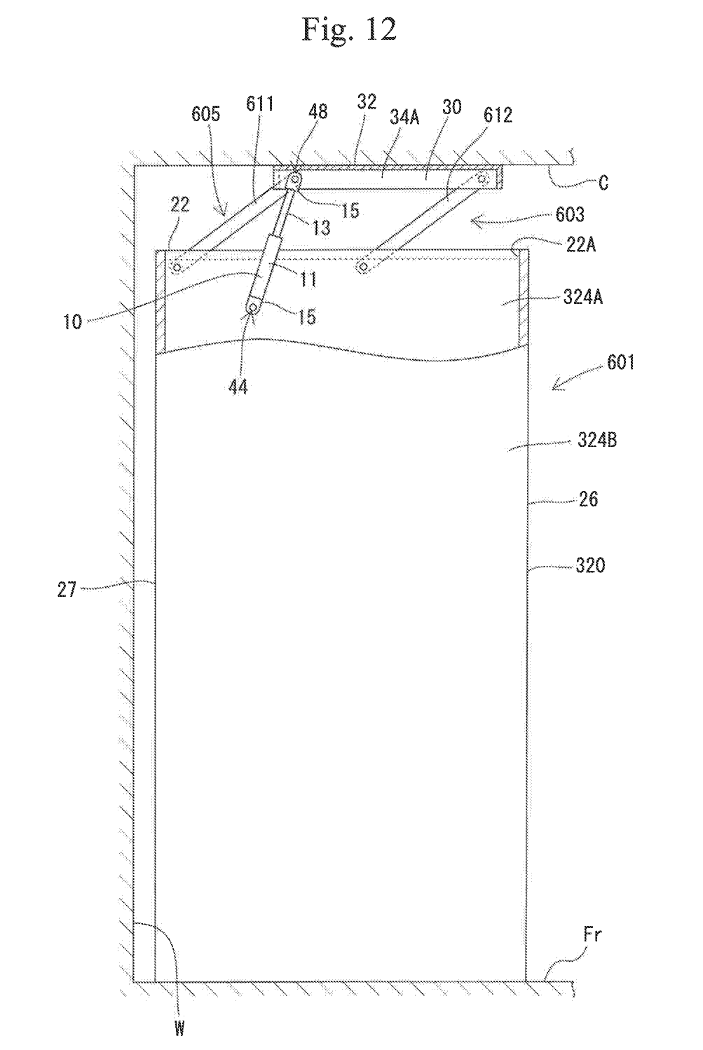

The furniture 601 of a sixth embodiment as illustrated in FIGS. 12 to 14 mainly differs from the third embodiment in the provision of a link 603. Accordingly, the configurations other than the link 603 are labeled by the same reference symbols as those in the third embodiment and detailed description will be eliminated. Although the configuration of FIG. 12 slightly differs from the third embodiment in the mounting positions of the dampers 10, the mounting positions can be variously changed and the mounting structure of the dampers 10 can be the same as in the third embodiment.

As illustrated in FIG. 12, the furniture 601 of the sixth embodiment includes the furniture body 320 disposed between the installation surface Fr and the ceiling C at the time of installation, the plate-like abutting member 30 disposed between the ceiling C and the furniture body 320 at the time of installation, and the operating part 605.

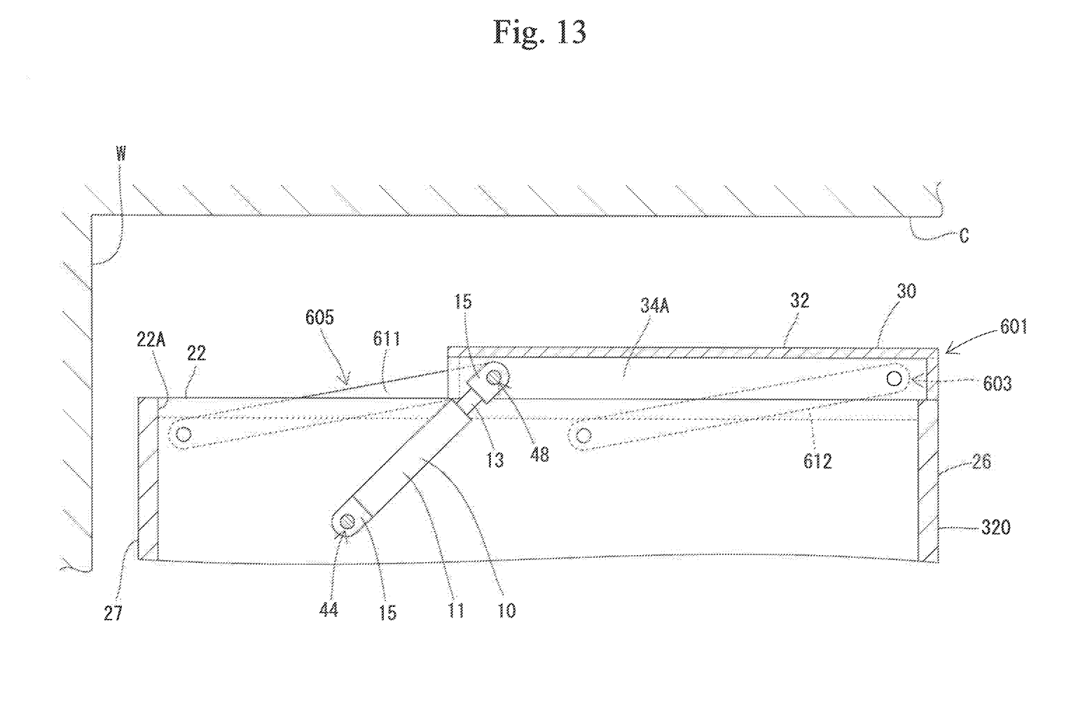

In the operating part 605, the configuration of a plurality of the dampers 10 (the damper at the other widthwise side is omitted) is the same as that in the third embodiment, and the link 603 is added to the structure. One end of each damper 10 is coupled to the furniture body 320 and the other end of each damper 10 is coupled to the abutting member 30. Each damper 10 has the same structure as each damper in the first embodiment. The operating part 605 is configured such that the dampers 10 become the contracted state when the abutting member 30 is disposed at the initial position near the furniture body 320 side as illustrated in FIG. 13. The operating part 605 is operated such that the abutting member 30 is moved to the developed position upwardly farther away from the furniture body 320 than the initial position according to extension of the dampers 10 thereby to be caused to abut against the ceiling C, as illustrated in FIG. 13.

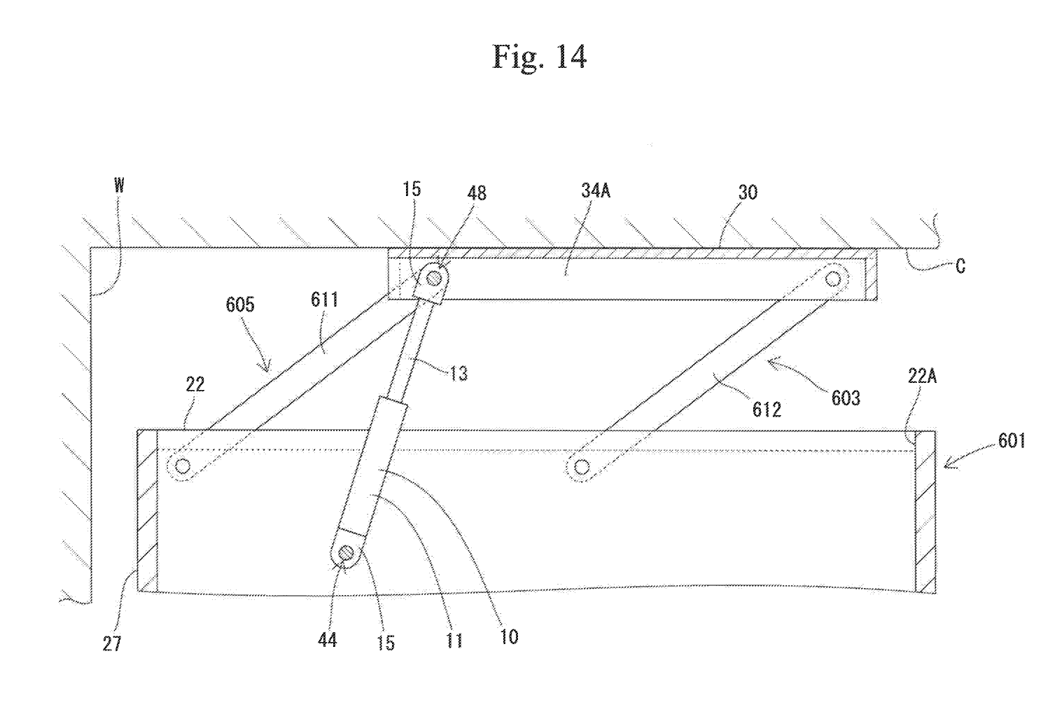

In the furniture 601, the operating part 605 has the link 603 connecting the abutting member 30 and the furniture body 320 and displaced according to extension/contraction of the dampers 10. The link 603 includes a pair of link members 611 and 612 each of which has two ends which are respectively coupled to the sidewall 324A of the furniture body 320 and the side plate 34A of the abutting member 30 so as to be rotatable. The link members 611 and 612 are configured to be rotated while being kept parallel to each other, so that the positions of upper ends of the link members 611 and 612 are always maintained at the same level. As a result, the top plate 32 of the abutting member 30 coupled to the link members 611 and 612 are moved up and down while being maintained in the horizontal state. The link 603 thus constructed inclines the dampers 10 and guides the abutting member 30 to the initial position side when the dampers 10 are contracted as illustrated in FIG. 13. And as illustrated in FIG. 14, the link 603 is operated such that the dampers 10 are raised in conjunction with extension of the dampers 10 and the abutting member 30 is guided to the developed position. Although the one widthwise side link is illustrated in FIGS. 12 to 14, a similar link can be provided at the other widthwise side.

According to this configuration, the dampers 10 are inclined so that the entire article can be rendered compact when dampers 10 are contracted, and the link is operated in conjunction with extension of the dampers so that the dampers can automatically be raised at the time of installation. Such a configuration of the furniture 601 can also achieve the same advantageous effect as the furniture 301 of the third embodiment.

### Seventh Embodiment

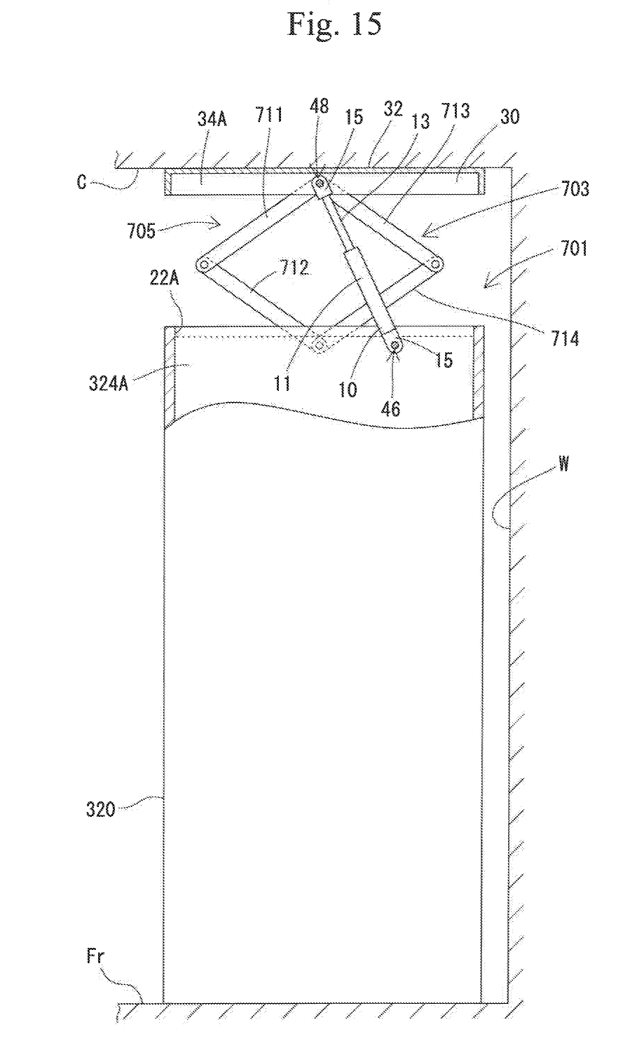

The furniture 701 of a seventh embodiment as illustrated in FIGS. 15 to 17 mainly differs from the third embodiment in the provision of a link 703. Accordingly, the configurations other than the link 703 are labeled by the same reference symbols as those in the third embodiment and detailed description will be eliminated. Although the configuration of FIG. 15 slightly differs from the third embodiment in the mounting positions of the dampers 10, the mounting positions can be variously changed and the mounting structure of the dampers 10 can be the same as in the third embodiment.

As illustrated in FIG. 15, the furniture 701 of the seventh embodiment includes the furniture body 320 disposed between the installation surface Fr and the ceiling C at the time of installation, the plate-like abutting member 30 disposed between the ceiling C and the furniture body 320 at the time of installation, and the operating part 705.

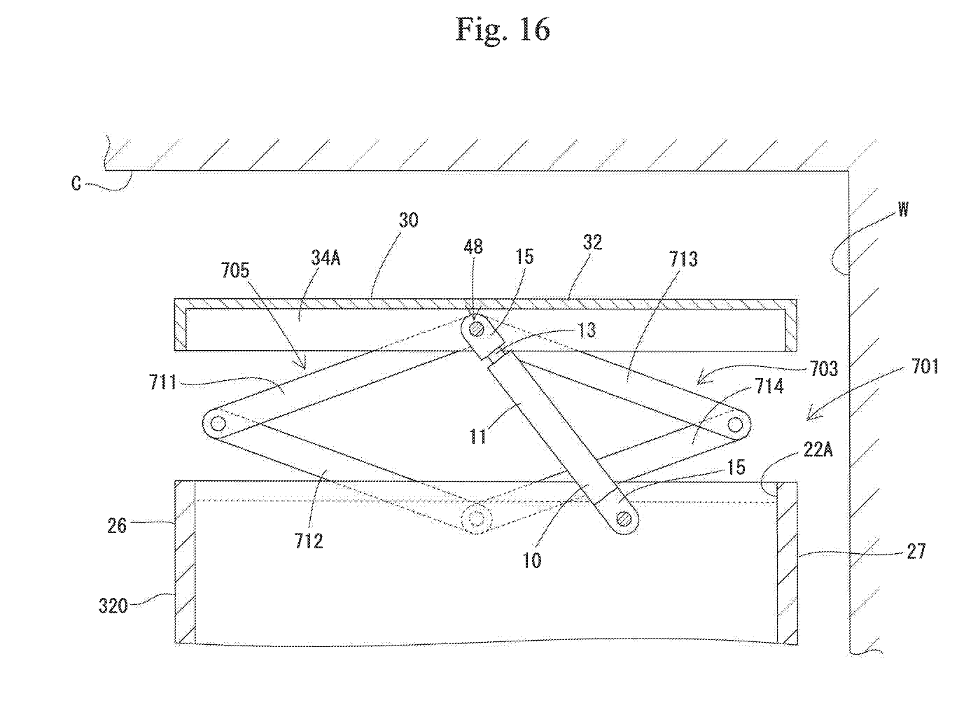

In the operating part 705, the configuration of a plurality of the dampers 10 is the same as that in the third embodiment, and the link 703 is added to the structure. One end of each damper 10 is coupled to the furniture body 320 and the other end of each damper 10 is coupled to the abutting member 30. Each damper 10 has the same structure as each damper in the first embodiment. The operating part 705 is configured such that the dampers 10 become the contracted state when the abutting member 30 is disposed at the initial position near the furniture body 320 side as illustrated in FIG. 16. The operating part 605 is operated such that the abutting member 30 is moved to the developed position upwardly farther away from the furniture body 320 than the initial position according to extension of the dampers 10 thereby to be caused to abut against the ceiling C, as illustrated in FIG. 16.

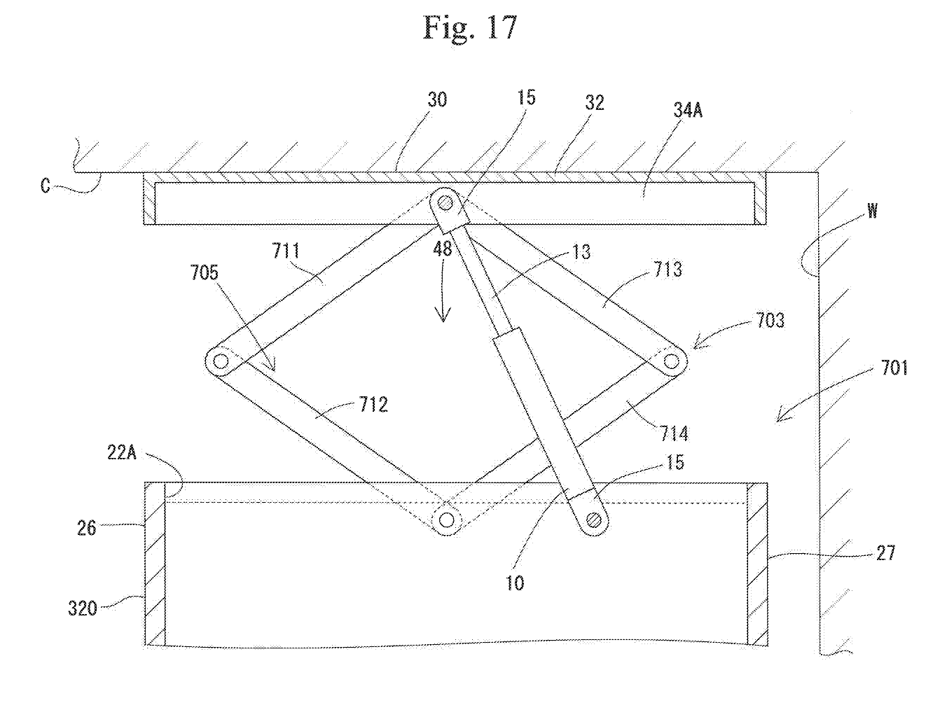

In the furniture 701, the operating part 705 has the link 703 connecting the abutting member 30 and the furniture body 320 and displaced according to extension/contraction of the dampers 10. The link 703 includes four link members 711, 712, 713 and 714 connected into a rhombus shape. The link members 711, 712, 713 and 714 are rotatably connected to one another. The link members 711 and 713 are rotatably coupled to the side plate 34A of the abutting member 30, and the link members 712 and 714 are rotatably coupled to the sidewall 324A of the furniture body 320. The link 703 thus constructed inclines the dampers 10 and guides the abutting member 30 to the initial position side when the dampers 10 are contracted as illustrated in FIG. 16. And as illustrated in FIG. 17, the link 703 is operated such that the dampers 10 are raised in conjunction with extension of the dampers 10 and the abutting member 30 is guided to the developed position. Although the one widthwise side link is illustrated in FIGS. 15 to 17, a similar link can be provided at the other widthwise side.

According to this configuration, too, the dampers 10 are inclined so that the entire article can be rendered compact when dampers 10 are contracted, and the link is operated in conjunction with extension of the dampers 10 so that the dampers 10 can automatically be raised at the time of installation. Such a configuration of the furniture 701 can also achieve the same advantageous effect as the furniture 301 of the third embodiment.

### Eighth Embodiment

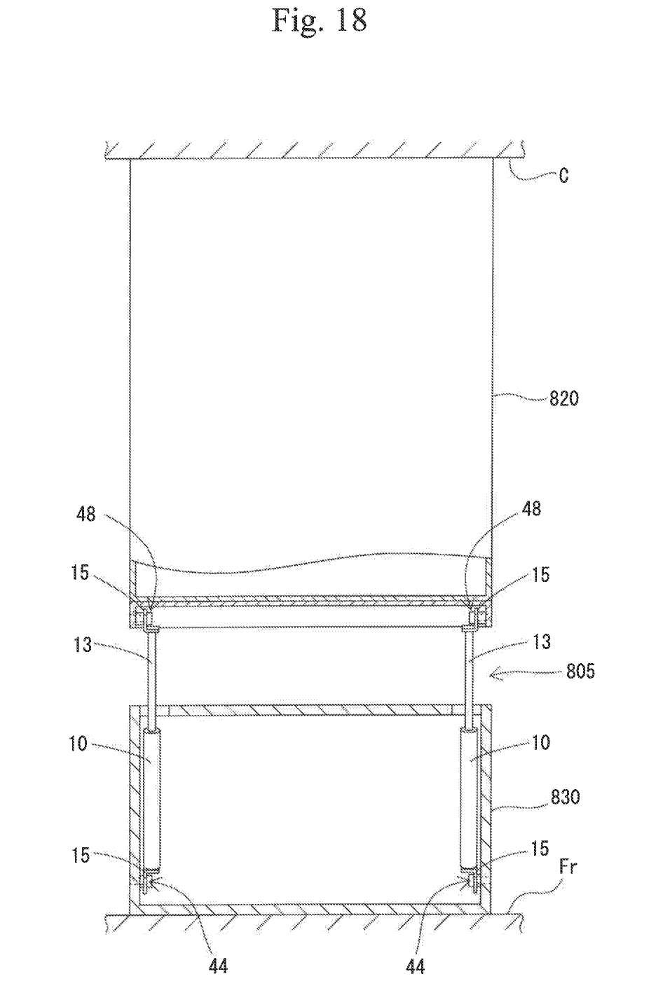

Next, an eighth embodiment will be described with reference to FIG. 18 etc. In the furniture 801 of the eighth embodiment as illustrated in FIG. 18, the furniture body 820 serving as the article body is disposed above, and the box-like abutting member 830 is disposed below. In the furniture 801, parts constructed in the same manner as in the first embodiment will be labeled by the same reference symbols as those in the first embodiment, and detailed description of these parts will be eliminated.

As illustrated in FIG. 18, the furniture 801 of the eighth embodiment includes the furniture body 820 disposed between the installation surface Fr and the ceiling C at the time of installation, the box-like abutting member 830 disposed between the installation surface Fr and the furniture body 820 at the time of installation, and the operating part 805. In the operating part 805, one end (upper end) of each damper 10 is coupled to the furniture body 820 and the other end (lower end) of each damper 10 is coupled to the abutting member 830. Each damper 10 has the same structure as each damper in the first embodiment. The operating part 805 is configured such that the dampers 10 become the contracted state when the abutting member 830 is disposed at the initial position near the furniture body 820 side (that is, when the furniture body 820 is located at the lower position away from the ceiling C and is close to the abutting member 830). The operating part 805 is operated such that the abutting member 830 is relatively moved to the developed position downwardly farther away from the furniture body 820 than the initial position according to extension of the dampers 10 so that the abutting member 830 and the ceiling C are caused to depart from each other, as illustrated in FIG. 18. With this operation, the furniture body 820 is installed so as to abut against the ceiling C. The configuration of the furniture body 801 as described above can achieve the same advantageous effect as in the furniture 1 of the first embodiment.

The present invention should not be limited to the embodiments described above with reference to the drawings, but the technical scope of the invention encompasses the following embodiments, for example.

(1) Although the overturn preventing device is mounted on the furniture in each of the first to eighth embodiments, the overturn preventing device may be mounted on an article such as a bookshelf or a refrigerator which has a possibility of overturn by shaking of earthquake or the like.
(2) Although the dampers 10 are compression dampers in each of the first to eighth embodiments, the dampers 10 may be two-way dampers in each of which a damping force generated during extending operation equals a damping force generated during contraction. Alternatively, the dampers 10 may be extension dampers in each of which a damping force generated during extending operation is larger than a damping force generated during contracting operation.
(3) Although the damper enclosing a hydraulic fluid and a compressed gas in the cylinder is used in each of the first to eighth embodiments, a fluid-pressure damper enclosing another fluid or another type of damper may be used as long as it can exert a predetermined damping force in a contracting operation.
(4) In each of the first to eight embodiments, the compressed gas is enclosed in the cylinder so that an expansion force of the compressed gas acts in an extension direction. However, a force acting in the extension direction may be generated in another manner.
(5) Although the article side adjuster is configured in such a manner that a plurality of through holes are provided in the sidewall in each of the first to eighth embodiments, it should not be limited to this configuration. For example, a part of the article body to which the lower end of the damper is coupled may be configured to be slidable so that the part is slid up and down by a worm wheel structure or the like for level adjustment.
(6) In the first embodiment, the lower ends of the paired dampers 10A and 10B are connected to the furniture body 20 at the same connecting position by the common coupling member 44 in each of the adjusters 40A and 40B respectively provided at both widthwise sides. However, it should not be limited to this configuration. The lower ends of the paired dampers 10A and 10B may separately be fixed by separate connecting members. In this case, too, the fixed positions by the use of the respective connecting members may be changeable.

### EXPLANATION OF REFERENCE SYMBOLS

1, 201, 301, 401, 501, 601, 701, 801 . . . furniture (an article equipped with an overturn preventing device); 5, 205, 305, 605, 705, 805 . . . operating part; 7A, 7B, 207A, 207B . . . damper set; 9A, 9B, 209A, 209B . . . distance increasing part; 10 . . . damper; 20, 220, 320, 820 . . . furniture body (article body); 22 . . . upper wall; 22A, 22B . . . opening; 24A, 24B, 224A, 224B, 324A, 324B . . . sidewall; 30, 530, 830 . . . abutting member; 40A, 40B, 240A, 240B, 240C, 240D . . . adjuster (article body side adjuster); 371, 372 . . . angle regulator; 450 . . . guide; 451A . . . distance limiter; 480 . . . adjuster (abutting member side adjuster); 603, 703 . . . link; C . . . ceiling; and Fr . . . floor surface (installation surface).

1. An article equipped with an overturn preventing device, comprising:
an article body to be disposed between an installation surface and a ceiling;
an abutting member to be disposed between either the installation surface or the ceiling and the article body; and
an operating part including a damper having two ends one of which is coupled to the article body and the other of which is coupled to the abutting member, the operating part being configured to move the abutting member to an initial position near the article body side according to contraction of the damper and move the abutting member to a developed position farther away from the article body than the initial position according to extension of the damper.

2. The article according to claim 1, wherein:
two damper sets each including a pair of the dampers are respectively mounted at both sides in a predetermined width direction of the article body; and
each damper set has a distance increasing part in which a front-back distance between one damper and the other damper in a predetermined front-back direction perpendicular to the width direction becomes larger as coming close to the abutting member.

3. The article according to claim 2, wherein each damper set has a front side damper having a coupling position to the abutting member, which position is located ahead of a coupling position to the article body, and a rear side damper having a coupling position to the abutting member, which position is located in the rear of a coupling position to the article body.

4. The article according to claim 1, wherein:
the operating part has a link coupling the abutting member and the article body and configured to be displaced according to extension/contraction of the damper; and
the link inclines the damper and guides the abutting member to the initial position side when the damper is contracted, and raises the damper and guides the abutting member to the developed position in conjunction with extension of the damper.

5. The article according to claim 1, further comprising a guide which limits a horizontal movement range of the abutting member when the damper is extended/contracted.

6. The article according to claim 1, further comprising a distance limiter which prevents a distance between the abutting member and the article body from being increased over a previously set maximum distance.

7. The article according to claim 1, wherein:
the article body includes a sidewall and an upper wall;
the upper wall is formed with a opening penetrating therethrough;
the damper is coupled to an inner wall side of the sidewall and inserted through the opening of the upper wall.

8. The article according to claim 1, wherein the dampers are respectively coupled to both widthwise ends of the article body.

9. The article according to claim 1, wherein a plurality of the dampers is coupled to the article body at an identical coupling position, the article further comprising an article body side adjuster which adjusts the coupling position of the dampers in the article body.
